(19) United States
(12) Patent Application Publication
(10) Pub. No.: US 2026/0100091 A1
(43) Pub. Date: Apr. 9, 2026

(54) Multifunctional keypad and Utility Box for Casino Table Games

(71) Applicant: Tavolo Intellect LLC, Grosse Pointe, MI (US)

(72) Inventor: Ryan Patrick McClellan, Grosse Pointe, MI (US)

(21) Appl. No.: 19/350,312

(22) Filed: Oct. 6, 2025

Related U.S. Application Data
(60) Provisional application No. 63/856,849, filed on Aug. 4, 2025.
(60) Provisional application No. 63/757,399, filed on Feb. 12, 2025.
(60) Provisional application No. 63/713,626, filed on Oct. 30, 2024.
(60) Provisional application No. 63/703,396, filed on Oct. 4, 2024.

(51) Int. Cl. G07F 17/32

(52) U.S. Cl. CPC G07F 17/322; G07F 17/3209

(57) ABSTRACT

A multifunctional keypad is provided for use on a casino gaming table to monitor and support dealer performance. The keypad is mounted to the gaming surface near a chip tray, card shoe, and betting regions, and is electrically connected to a table monitoring system comprising a processor and memory. The processor receives and timestamps gameplay data from detection devices, computes rolling averages of hands dealt, compares values to thresholds, and generates real-time dealer alerts. The keypad includes secure attachment devices, an electronics unit, communication interfaces, and a slot for passing currency or paperwork into a drop box below the table. Input devices allow the dealer to record information and display it on a table sign visible to players, while output devices convey performance alerts to the dealer. Metrics conveyed include hand counts, rolling averages, threshold comparisons, and numbers of winning or losing hands since the last shuffle.

### CROSS-REFERENCE TO RELATED APPLICATIONS

The disclosures of US provisional applications 63/856,849 filed on August 04, 2025, US 63/757,399 filed on February 12, 2025, US 63/713,626 filed on October 30, 2024, and US 63/703,396 filed on October 04, 2024 are all incorporated by reference herein in their entireties for all purposes.

### FIELD

These teachings relate to casino table games, and more specifically to a multifunctional keypad for casino table games.

### BACKGROUND

Dealers of casino table games, such as blackjack and roulette, typically exchange players’ currency for gaming chips. A drop box, usually positioned at the table, securely stores the collected cash and related paperwork. It typically consists of a canister connected to a slot defined in the table’s surface. Dealers insert the money or documents through the slots and into the drop box. A faceplate, often a 5” x 5” x 0.4” plastic or metal frame, may surround or partially conceal the slot to give the table a more polished appearance.

Casino gaming tables often include multiple standalone devices used by the dealer to manage gameplay. Such devices may include one or more table signs, card readers or cameras for player identification, TITO ticket printers, and devices for communicating with management or security. While functional, having numerous separate devices can clutter the table, distract the dealer, and reduce available space. This clutter may undesirably force a dealer to divert their attention from the game, potentially slowing gameplay, and diminishing the player experience. The disorganized appearance may also confuse or frustrate players. It may therefore be desirable to improve the current state of the art.

For example, to improve efficiency and reduce clutter on the table, it may be beneficial to integrate or consolidate at least two or more devices and functions typically found on a gaming table into a single, unified device. This may enable the dealer to manage gameplay and communicate with casino staff or players more quickly and accurately. Consolidating these functions would also free up table space, minimizing distractions for both dealers and players. Additionally, a cleaner, less complex table design may help new or prospective players feel more comfortable and welcome.

Some casinos lack ability to communicate performance and/or game play metrics to casino table dealers in real time. For example, a dealer or casino employee who is made aware that they are performing at or below a predetermined metric or goal may be incentivized or motivated to improve their performance to meet or exceed a predetermined metric or goal. A dealer or casino employee who is made aware that they are meeting or exceeding expectations or goals may be motivated or incentivized to continue performing at the level. It would be desirable to improve the current state in the art to have a device, method, and/or system to communicate performance and/or game play metrics to one or more casino gaming table dealers or other staff directly at the table, without adding yet another individual or discrete device to the gaming table and without distracting or notifying players at the gaming table.

A casino may include one or a plurality of individual and discreet devices to communicate information to casino patrons. For example, a casino table may include a signage system for communicating information to a casino patron related to the game name, rules of the game, and/or minimum and maximum wagering amounts. Some signage systems also have a rear facing screen for casino staff to interact with. For example, casino staff may change information that is displayed on the front facing screen to casino patrons and/or input patron information into a player rating system. While currently available signs are adequate for their intended purpose, improvement in the art may be desired. For example, some signage systems and/or casino management systems include one or more peripherals for the casino staff to use, such as a card reader, finger print scanner, etc. However, these peripherals are sometimes in a location that may be difficult for the casino staff to locate and operate, especially during busy game play and/or low lighting conditions. Locating and/or operating these ancillary devices may require the dealer to leave their dealing position which may slow down the pace of the game and/or put the security or integrity of the game at risk. Accordingly, it would be desirable to have a signage system that overcomes at least these shortcomings in currently available signage systems.

It may be desirable to improve the current state in the art by having a system and method for managing, monitoring, and/or interacting with casino table games.

### SUMMARY

The present disclosure relates to a multifunctional keypad for a casino gaming table, as well as associated methods and systems for monitoring, determining, and displaying dealer performance metrics and statistics on the keypad and/or table sign.

Advantageously, the keypad is specifically configured to be mounted on the upper playing surface of a casino table, rather than off-table terminals or pit systems. The keypad advantageously integrates one or more slots or pass-throughs (for currency, chips, tickets, paperwork) aligned with table drop boxes — turning the keypad into a hybrid input + physical transaction device. The keypad incorporates slot apertures dimensioned to align with existing table openings, enabling the secure transfer of physical items (currency, tickets, chips) into under-table drop or utility boxes.

Advantageously, the keypad is configured to provide real-time, gameplay-based information directly to the dealer through the keypad. The information is not limited to administrative data but includes contextual gameplay metrics (hands dealt, rolling averages, thresholds, alerts, etc.) that can guide dealer behavior during live play.

Advantageously, the keypad is configured to be electrically coupled to a monitoring system with a processor and memory executing algorithms that receives and timestamps gameplay data from detection devices; aggregates and analyzes dealer/game activity; and transmits back dealer-useful prompts or alerts through the keypad interface.

The multifunctional keypad for casino gaming tables integrates with a table monitoring system to improve the tracking and evaluation of dealer performance. The keypad is configured for installation on the gaming table surface and communicates with detection devices positioned at or near the table. These devices capture gameplay data such as the number of hands dealt, chip and card activity, and other table events.

In one aspect, the keypad communicate with a table monitoring system. A system processor of the table monitoring system timestamps and analyzes gameplay data at the table to calculate dealer performance metrics, including weighted averages of various dealer activity. Metrics and statistics can be displayed on the keypad and/or a table sign visible to the dealer, casino personnel, and/or players. Associated methods and systems for monitoring, determining, and presenting such performance data in real time, enabling more accurate dealer evaluation, operational efficiency, and enhanced game integrity are disclosed herein.

The gaming table may include an upper gaming surface covered in a felt or fabric material, a chip tray containing gaming chips, a card shoe holding playing cards, and one or more betting regions.

In one aspect, the multifunctional keypad may be mounted on the upper gaming surface and electrically connected to one or more table signs. The one or more table signs may have one or more front display screens that is/are configured to face one or more players or perspective players. The one or more table signs may have one or more rear display screens that is/are configured to face a supervisor or pit boss. A dealer may control information that is displayed or presented on the front and/or rear screen via the multifunctional keypad. For example, a dealer may utilize one or more input devices on the keypad to display information on the front and/or rear screen relating to bet limits, advertisements, sports scores, promotional messages, dealer statistics (average number of hands dealt per hour, win streak, max payout amounts in the last 10 minutes, hour, shift, etc.), player statistics, (e.g., player win streaks), eligible player promotions, etc.

In one aspect, the multifunctional keypad may be mounted on the upper gaming surface and electrically connected to a table monitoring system. The table monitoring system comprises a processor and memory storing rules for calculating game play activity, the processor being configured to receive gameplay data from one or more detection devices provided at or adjacent to the gaming table. Based on the game play data, the processor may determine or compute various game play statistics, such as the number of hands dealt per time interval, compute rolling averages, compare the averages to one or more thresholds. The processor may timestamp the game play data and/or the game play statistics. The game play data and/or the game play statistics may be displayed on the keypad in real time (e.g., on one or more output devices) so the dealer is aware of their current performance. The game play data and/or the game play statistics may be displayed on the table sign in real time (e.g., on the front and/or rear screens) so the players, perspective players, and/or supervisor is aware of the dealer’s streak or current performance.

The multifunctional keypad may include attachment devices for securing it to the table surface, an electronics device, one or more communication devices for interfacing with the table monitoring system, a slot for passing currency or paperwork into a drop box or utility box beneath the table, one or more input devices for receiving dealer input and for controlling or updating a table sign visible to players, and one or more output devices for conveying information to the dealer. Output devices may include a display screen, light indicator, speaker, or haptic feedback device, while input devices may include a touchscreen, LCD with integrated touch input, physical keypad, button, knob, switch, or microphone. The keypad and monitoring system may convey dealer alerts in real time, typically within two seconds of data acquisition.

Dealer alerts may be displayed on the keypad. A dealer alert may include one or more performance metrics such as the number of hands dealt per time interval, rolling averages, whether dealer activity performance meets a threshold, number of winning and losing hands within a certain time period, and the number of hands dealt since a last shuffle. Dealer alerts may also provide assistance information such as hands carried over from a previous session, time remaining in a shift or until a break, or error notifications. The processor may generate assistance information by processing gameplay data to predict outcomes, comparing predicted to actual outcomes, and providing corresponding payout values, relevant game rules, or instructions to guide the dealer in resolving discrepancies with players. The dealer assistance information may be communicated to the dealer via the keypad.

The dealer alert that includes the performance metric and/or assistance information is not a disembodied rule stored in memory or a mere mathematical concept in the abstract. Instead, the dealer alert is generated through interaction with specific detection devices and delivered as a real-time output alert. The alert results from analyzing gameplay activity as it occurs at the gaming table—reflecting both dealer and player actions—and applying machine-learning or deep-learning algorithms that execute rules based on the observed activity. As the processor or learning model continues to be trained over time, the accuracy and confidence of the generated performance metrics and assistance information provided to the dealer in real time are further improved. The keypad may incorporate acknowledgement buttons (as one or more input devices) that enable validation of an alert’s accuracy, thereby informing and refining the model when an alert is correct. Conversely, the acknowledgement buttons may be used to override or discard an inaccurate alert, signaling the model to adjust and produce improved future outcomes. These acknowledgement inputs may be provided through the keypad itself, the player-facing sign, a supervisor or pit-boss station, or the casino surveillance system, or any combination thereof. In this regard, the teachings herein integrate real-time data acquisition, machine-learning analysis, and tangible input/output hardware into a specific, practical application that provides significantly more than an abstract idea. These alerts are dynamically refined through acknowledgement inputs from physical devices at the table, player sign, or supervisory stations, thereby improving accuracy over time. This integration of hardware and software provides significantly more than any alleged abstract rule or mathematical calculation.

The monitoring system may further incorporate one or more detection devices (e.g., cameras) positioned at the table sign, chip tray, or integrated with a casino surveillance system to capture gameplay data. The processor may retrieve player-related information from a database, such as whether a player has presented a loyalty card, whether a player has been identified as an advantage player, or whether a player has been restricted or banned, and may convey such information to the dealer through the multifunctional keypad.

In another aspect, methods of operating a casino gaming table are disclosed. The methods include installing the multifunctional keypad, electrically connecting it to the monitoring system, collecting and timestamping gameplay data via detection devices, aggregating and analyzing dealer performance, generating and transmitting dealer alerts, and outputting the alerts in real time. The dealer alerts may be provided onto the table sign (e.g., front and/or rear sign), keypad, or both, so the dealer, supervisor, and/or players can understand various performance metrics in real time. The method further includes generating dealer assistance information, retrieving player data from a database, calculating payout values, presenting relevant game rules, and providing discrepancy-resolution instructions.

In another aspect, a casino gaming table system is disclosed comprising the gaming table, the monitoring system, and the multifunctional keypad as described above. The integrated system supports monitoring of gameplay, provision of dealer performance and assistance metrics, retrieval of player-related information, and communication of real-time alerts and instructions to the dealer during live game play. A multifunctional keypad is described herein that is configured to improve the state in the art. For example, the multifunctional keypad described herein advantageously consolidates various tasks typically handled by multiple staff members and separate devices at the gaming table. Its placement near the dealer ensures convenient access and ease of use. Additionally, it provides an effective means to communicate performance and gameplay metrics directly to dealers or other table staff. Other advantages of these teachings will be apparent to those skilled in the art. A utility box is described herein that is configure to improve the state in the art.

These teachings provide a multifunctional keypad and utility box for a gaming table at a casino. The gaming table may comprise an upper gaming surface covered in a felt or fabric material. At the upper gaming surface, the gaming table may include a chip tray comprising gaming chips, a card shoe comprising playing cards, one or more betting regions. On one or more slots (e.g., utility box slots or openings) may be located through a thickness of the gaming table or gaming surface and arranged adjacent to the chip tray. The one or more slots (e.g., utility box slots or openings) may be at least partially aligned with one or more slots or openings of the utility box that is located at or below the gaming table. The multifunctional keypad may be configured to be installed on the upper gaming surface and further configured to be electrically connected to a table monitoring system comprising one or more detection devices.

These teachings also provide a multifunctional keypad and utility box for a gaming table at a casino, the gaming table comprising an upper gaming surface covered in a felt or fabric material, and located at the upper gaming surface is a chip tray comprising gaming chips, a card shoe comprising playing cards, one or more betting regions, and a utility box slot located adjacent to the chip tray and at least partially aligned with the utility box that is located at or below the gaming table, wherein the multifunctional keypad is configured to be installed on the upper gaming surface and further configured to be electrically connected to a table monitoring system comprising one or more detection devices, the utility box is configured to be secured to a bottom surface of the gaming table and comprises a first chamber and a second chamber, the first chamber is isolated from the second chamber via a wall and is configured to receive and at least temporarily store currency and/or ticket vouchers, the second chamber comprises a ticket printer; the multifunctional keypad comprises: one or more attachment devices for securing the multifunctional keypad to the upper gaming surface of the gaming table; an electronics device; one or more power and/or communication devices that are configured to electrically connect the electronics device of the table monitoring system and/or a power source; a first slot through which currency and/or paperwork is configured to be passed through the multifunctional keypad and into the first chamber; and a second slot, through which tickets printed by the ticket printer in the second chamber are configured to be passed through for presentation to a dealer. The multifunctional keypad comprises a wall that separates the first slot and the second slot. A size of the first slot is larger than the second slot, the first slot is dimensioned and configured for a plunger to be used to push the currency and/or ticket vouchers through the first slot. The second slot is dimensioned and configured to prevent currency and/or ticket vouchers from being inserted into the second slot. The multifunctional keypad comprises a serrated edge at the second slot to allow a printed ticket to be ripped or separated from another ticket. The second chamber comprises a stack or roll of tickets configured to be supplied to the ticket printer. The utility box comprises a drawer that is configured to slide out of the utility box in a generally horizontal direction relative to the upper gaming surface to remove contents from the first chamber. The utility box comprises a bottom door that is configured to open to remove contents from the first chamber. The multifunctional keypad comprises: one or more input devices electrically connected to the electronics device and accessible to the dealer to input information into the electronics device of the multifunctional keypad and to a device or table sign that is electrically connected to the multifunctional keypad for viewing by one or more players at the gaming table; one or more output devices electrically connected to the electronics device and accessible to the dealer to communicate information to the dealer; and one or more card readers electrically connected to the electronics device and accessible to the dealer for swiping one or more player club or loyalty cards and/or dealer identification cards. The utility box comprises a top surface having a first utility box slot and a second utility box slot, wherein the first utility box slot is aligned with and in communication with the first slot of the multifunctional keypad and the first chamber of the utility box, and the second utility box slot is aligned with and in communication with the second slot of the multifunctional keypad and the second chamber of the utility box. The utility box comprises a top surface having a first utility box slot, wherein the first utility box slot is aligned with and in communication with the first slot of the multifunctional keypad and the second slot of the multifunctional keypad, wherein the utility box comprises a diverter wall that is downstream of the first utility box slot to separate the first chamber and the second chamber. The multifunctional keypad comprises: one or more tip devices electrically connected to the electronics device and accessible to the dealer to input tip information received by the dealer from one or more players.

A multifunctional keypad and utility box for a gaming table at a casino is disclosed, the gaming table comprising an upper gaming surface covered in a felt or fabric material, and located at the upper gaming surface is a chip tray comprising gaming chips, a card shoe comprising playing cards, one or more betting regions, and a utility box slot located adjacent to the chip tray and at least partially aligned with the utility box that is located at or below the gaming table, wherein the multifunctional keypad is configured to be installed on the upper gaming surface and further configured to be electrically connected to a table monitoring system comprising one or more detection devices, the utility box is configured to be secured to a bottom surface of the gaming table and comprises a first chamber and a second chamber, the first chamber is isolated from the second chamber via a wall and is configured to receive and at least temporarily store currency and/or ticket vouchers, the second chamber comprises a ticket printer; the multifunctional keypad comprises: one or more attachment devices for securing the multifunctional keypad to the upper gaming surface of the gaming table; an electronics device; one or more power and/or communication devices that are configured to electrically connect the electronics device of the table monitoring system and/or a power source; and a first slot through which currency and/or paperwork is configured to be passed through the multifunctional keypad and into the first chamber. The multifunctional keypad comprises: one or more input devices electrically connected to the electronics device and accessible to the dealer to input information into the electronics device of the multifunctional keypad and to a device or table sign that is electrically connected to the multifunctional keypad for viewing by one or more players at the gaming table; one or more output devices electrically connected to the electronics device and accessible to the dealer to communicate information to the dealer; and one or more card readers electrically connected to the electronics device and accessible to the dealer for swiping one or more player club or loyalty cards and/or dealer identification cards. The utility box comprises a drawer that is configured to slide out of the utility box in a generally horizontal direction relative to the upper gaming surface to remove contents from the first chamber. The utility box comprises a bottom door that is configured to open to remove contents from the first chamber. The multifunctional keypad comprises: one or more tip devices electrically connected to the electronics device and accessible to the dealer to input tip information received by the dealer from one or more players. Tickets printed by the ticket printer in the second chamber are configured to be presented to a dealer of the casino table in a region adjacent to the gaming table.

A multifunctional keypad and utility box for a gaming table at a casino, the gaming table comprising an upper gaming surface covered in a felt or fabric material, and located at the upper gaming surface is a chip tray comprising gaming chips, a card shoe comprising playing cards, one or more betting regions, and a utility box slot located adjacent to the chip tray and at least partially aligned with the utility box that is located at or below the gaming table, wherein the multifunctional keypad is configured to be installed on the upper gaming surface and further configured to be electrically connected to a table monitoring system comprising one or more detection devices, wherein the utility box is configured to be secured to the gaming table and comprises a first chamber and a second chamber, the first chamber is isolated from the second chamber via a wall and is configured to receive and at least temporarily store currency and/or ticket vouchers, the second chamber comprises a ticket printer, wherein tickets printed by the ticket printer in the second chamber are configured to be presented to a dealer of the casino table in a region adjacent to the gaming table or presented to the dealer on the upper gaming surface; wherein the multifunctional keypad comprises: one or more attachment devices for securing the multifunctional keypad to the upper gaming surface of the gaming table; an electronics device; one or more power and/or communication devices that are configured to electrically connect the electronics device of the table monitoring system and/or a power source; a first slot through which currency and/or paperwork is configured to be passed through the multifunctional keypad and into the first chamber; one or more input devices electrically connected to the electronics device and accessible to the dealer to input information into the electronics device of the multifunctional keypad and to a device or table sign that is electrically connected to the multifunctional keypad for viewing by one or more players at the gaming table; one or more output devices electrically connected to the electronics device and accessible to the dealer to communicate information to the dealer; one or more card readers electrically connected to the electronics device and accessible to the dealer for swiping one or more player club or loyalty cards and/or dealer identification cards. A backside of the multifunctional keypad is dimensioned and configured to be installed on the upper gaming surface on top of an existing frame that is attached to the upper gaming surface and that surrounds the utility box slot.

In some configurations, the multifunctional keypad includes a reconciliation input device, such as a dedicated button, touchscreen icon, or switch. The reconciliation feature enables a dealer to acknowledge, correct, or clear an error or inconsistency detected during gameplay. The error may be detected by the table monitoring system based on data from one or more detection devices, or it may be reported by a dealer, player, or supervisor. Upon dealer activation of the reconciliation input, the processor records both the timestamp of the detected error and the timestamp of the reconciliation event, associates the two in memory, and updates a system log to preserve a complete audit trail.

The multifunctional keypad may further comprise a tip input device configured to register tips received by a dealer. A gaming chip provided as a tip may be identified and verified by one or more detection devices, such as a camera or chip recognition system. The verified value of the chip may be stored in a digital wallet associated with the dealer and/or the casino. After registration, the chip may be returned to the chip tray for recirculation in gameplay. An output device on the keypad may provide a visual, audible, or haptic acknowledgment confirming that the tip has been successfully logged.

In some embodiments, the multifunctional keypad may be configured to stage player information for later entry into a player rating system. For example, when a dealer receives a player’s loyalty card or other identification at the table, the card reader on the keypad may capture the player identification data. The system may retrieve corresponding player information from a database, prompt the dealer to enter supplemental information such as seat number or buy-in amount, and store the combined data in a queue with an associated timestamp. Gameplay may proceed while the data remains staged, and a supervisor may be notified of the pending transaction via a rear-facing screen of a table sign or through a remote monitoring device. At a later time, the supervisor may complete the transaction by transferring the staged information into the player rating system.

In an embodiment, card swipe information gathered through the keypad 100 may be stored in association with supplemental dealer-entered information such as seat number, buy-in amount, or transaction details. This information may be maintained in a queue until a supervisor or pit boss arrives at the table. Upon arrival, the queued information may be displayed as an overlay on a rear or staff-facing side of the table sign, or on the keypad 100 itself. The supervisor may then complete the intake process by selecting or confirming a seating position for the player, if required by the player rating system, and activating a “swipe virtual card” function. Activation of the virtual card swipe function causes the data acquired from the dealer’s initial card swipe to be presented electronically to the player rating system for player lookup and verification.

In an embodiment, the order of operations may vary such that the “swipe virtual card” action occurs first, followed by the seat assignment, or vice versa. The supervisor may also be prompted to add or verify additional supplemental data, such as player notes, loyalty status, or transaction history, which may then be stored in the player’s profile in the rating system. Advantageously, this process allows the initial card swipe captured at the table to be re-used electronically by casino staff without requiring the physical card to be re-presented, thereby streamlining player registration, reducing redundant inputs, and enabling the player to begin or continue gameplay without interruption.

### BRIEF DESCRIPTION OF THE DRAWINGS

FIG. 1 is an overhead view of a gaming table.

FIG. 2A is a front view of a sign.

FIG. 2B is a back view of a sign.

FIG. 2C is a view of a rear screen.

FIG. 2D is a side view of a sign.

FIG. 2E is a side view of a sign.

FIG. 3 is an overhead view of an exemplary multifunctional keypad for a gaming table.

FIG. 4 is a perspective view of an exemplary multifunctional keypad for a gaming table.

FIG. 5 is a cross sectional view of a portion of a gaming table, keypad, and a utility box.

FIG. 6 is a cross sectional view of a portion of a gaming table, keypad, and a utility box.

FIG. 7 is a cross sectional view of a portion of a gaming table, keypad, and a utility box.

FIG. 8 is a perspective view of a utility box.

FIG. 9 is a perspective view of the utility box of FIG. 7, with the door in an open position.

FIG. 10 is a perspective view of a utility box.

FIG. 11 is a cross sectional view of a portion of a gaming table, keypad, and a utility box.

FIG. 12 is a top view of a detection device for use with a chip tray.

FIG. 13 is a perspective view of a chip tray that includes the detection device of FIG. 12.

### DETAILED DESCRIPTION

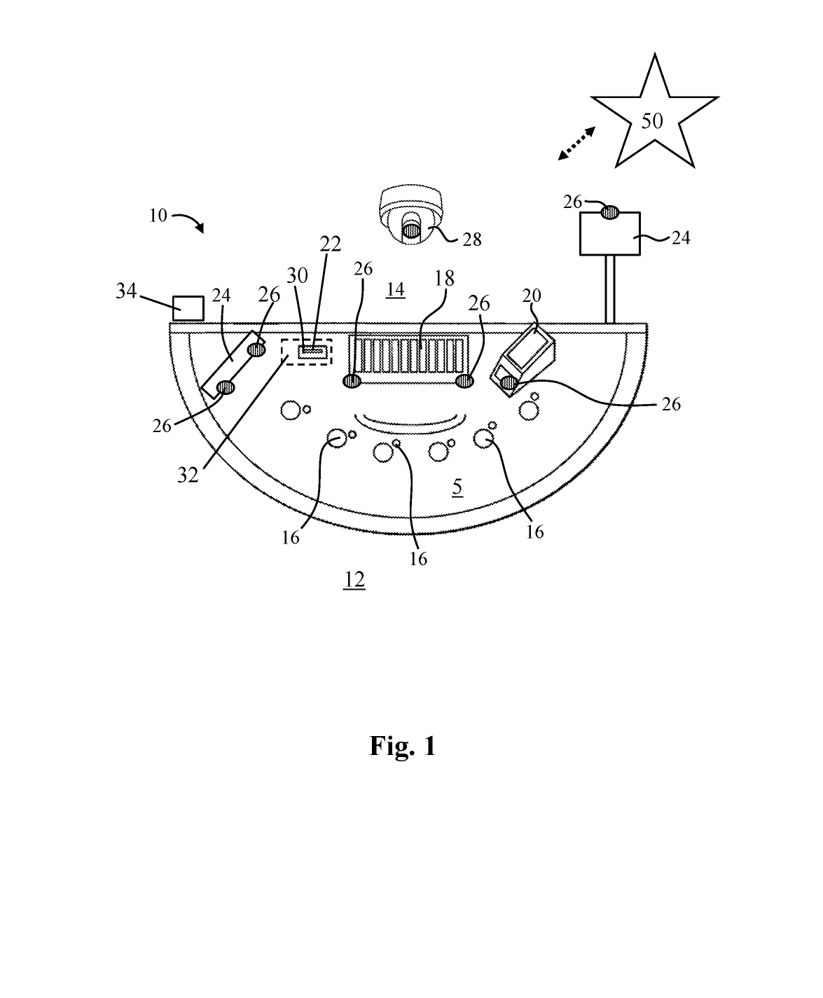

FIG. 1 illustrates various elements located on or associated with a gaming table 10. Some or all of these elements may interface with, or be operatively connected to, the keypad 100, table sign 24, and/or a table or game monitoring system 50 for managing, monitoring, and interacting with the casino gaming table. In particular, the elements of the gaming table 10 may be electronically connected to the monitoring and/or processing system 50 via a wired and/or wireless communication link.

Generally, a gaming table 10 comprises an upper gaming surface or top 5 that may be covered with a material like felt or fabric. The gaming table 10 has a player side or area 12 and a dealer side or area 14. The player area 12 comprises one or more betting regions 16 on the gaming surface or top 5 where one or more players can place bets during game play. At the dealer side or area 14 and located at or on the gaming surface 5, the gaming table 10 comprises a chip tray 18 comprising gaming chips, a card shoe 20 comprising playing cards, and a drop box slot 22. Such a gaming table 10 may be referred to as a card table (e.g., poker, blackjack, etc.). One or more displays or signs 24 (two are shown in this example) may be provided adjacent to and/or at/on a gaming table 10. The one or more signs 24 may be part of the table or game monitoring system 50.

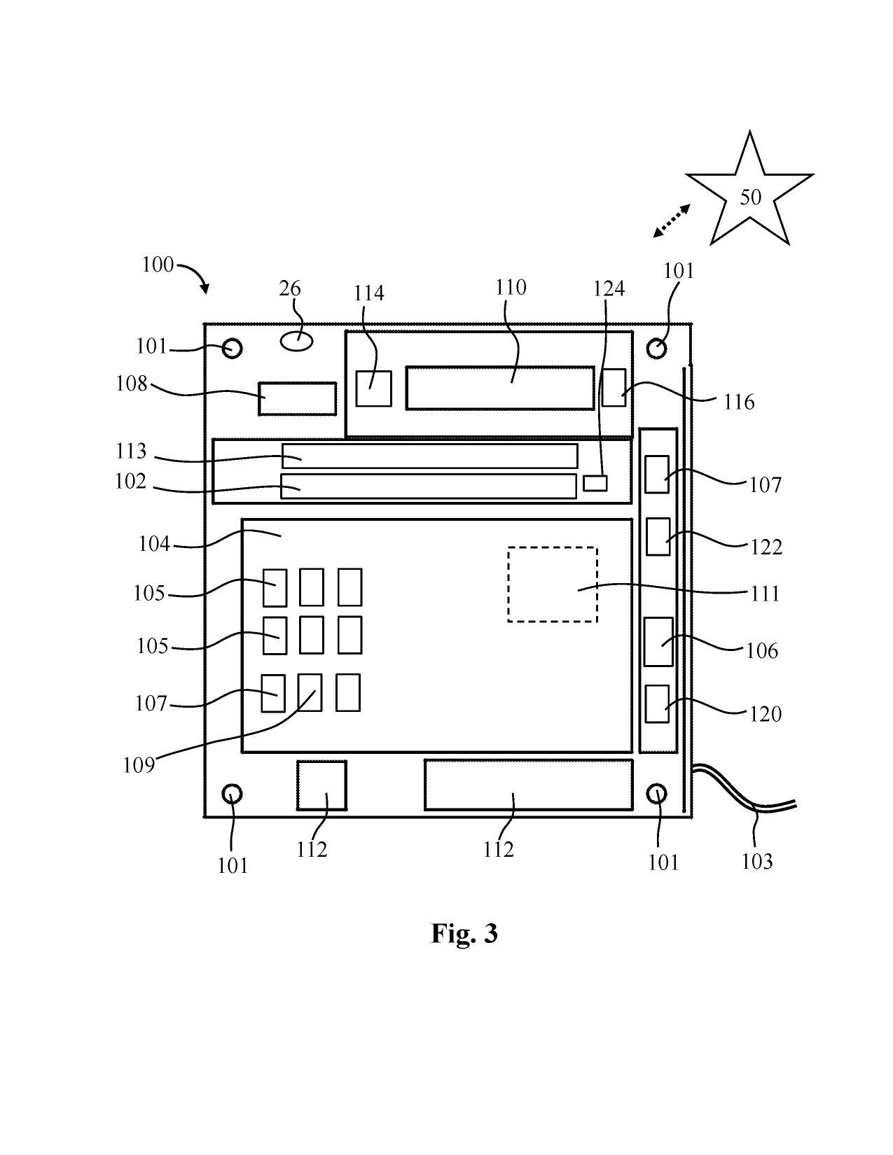

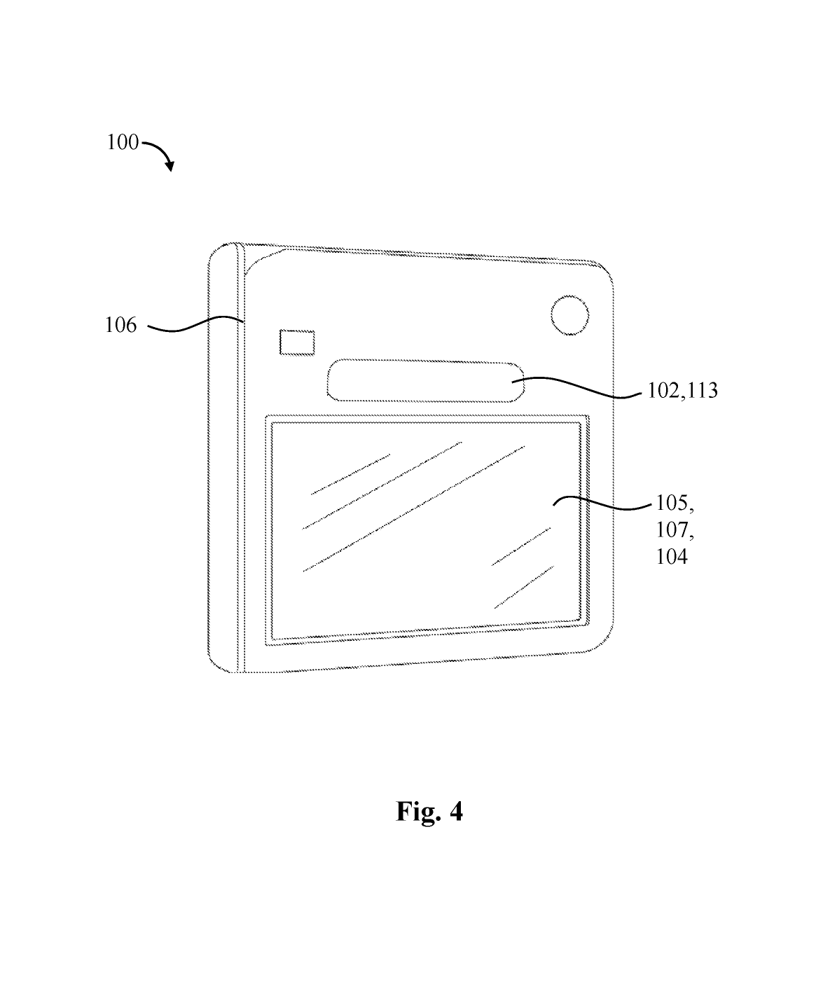

As discussed herein, one or more of the signs 24, the faceplate 100, which may also be referred to herein as a multifunctional keypad 100 for a gaming table at a casino (FIG. 3 and 4), and/or features of the chip tray 18 may be electronically connected to the table monitoring and/or processing system 50 by way of a wired and/or wireless communication system. In some configurations, the table monitoring and/or processing system 50 may be part of the table, sign, faceplate, chip tray, shoe, etc., and one or more of the aforementioned elements on the table 10 may be connected thereto via a wired or wireless communication system.

Other exemplary gaming tables may comprise a roulette wheel with a plurality of numbered pockets, one or more roulette balls, a plurality of betting regions on the top gaming surface where one or more players can place bets, and a chip tray comprising one or more gaming chips. Such a gaming table 10 may be referred to as a roulette table.

Other exemplary gaming tables may comprise a plurality of dice, a plurality of betting regions on the top gaming surface 5 where one or more players can place bets, and a chip tray comprising one or more gaming chips. Such a gaming table 10 may be referred to as a craps table.

One or more detection devices 26 may be provided at, on, or adjacent to the gaming table 10. For example, one or more detection devices 26 may be located at, on, or incorporated into the gaming surface 5, the chip tray 18, the card shoe 20, roulette wheel, one or more betting regions, and/or the one or more signs 24. One or more detection devices 28 may also be located above the gaming table 10, which may be affixed to a ceiling and/or wall of the room or facility in which the gaming table 10 is located. One or more of the detection devices 26, 28 may be part of a casino surveillance system and/or a table monitoring system 50 described further below. One or more of the detection devices 26, 28 may monitor activity at and/or around the gaming table 10 before, during, and/or after game play. A detection device 26 may be a camera (still and/or video camera). An output of the one or more detection devices 26, 28 may be provided to one or more analyzing devices or processors that are part of or electrically connected to the monitoring system 50, to the multifunctional keypad 100, and/or to a casino surveillance network.

Other detection devices 26, besides or in addition to cameras, may be positioned adjacent to, distributed throughout, and/or integrated with elements of the gaming table. Such detection devices may include, without limitation, pressure sensors, load cells, or strain gauges configured to detect chip weight or chip movement within the chip tray; proximity sensors, ultrasonic sensors, or time-of-flight sensors configured to detect the presence or movement of objects near or on the gaming surface; optical sensors, infrared sensors, or thermal sensors configured to capture visual or non-visible light information relating to cards, chips, or dealer/player interactions; RFID readers or NFC devices configured to identify or track tagged chips, cards, or player loyalty cards; magnetic field sensors or Hall effect sensors configured to detect magnetic inserts in chips or cards; acoustic or vibration sensors configured to detect sound or movement events associated with gameplay; and biometric or identity-verification sensors, such as fingerprint, palm-vein, or hand-presence sensors, configured to authenticate a dealer or player. In general, the detection devices may be configured to monitor the presence, absence, movement, orientation, or state of gaming objects, dealer actions, and/or player interactions, using one or more of the foregoing technologies individually or in combination.

A gaming table 10 may include one or more drop box slots 22. A typical drop box slot 22 comprises a slot or opening that is defined at or in the upper gaming surface 5 of the table 10 and extends to the bottom or B-side of the table 10. In other words, the slot 22 extends through a thickness of the table top or gaming surface.

A utility box or drop box 32 may be located at the bottom or B-side of the gaming table 10 and/or adjacent to the table and at least partially aligned with the slot 22. The utility box 32 comprises a flat or planar top surface. The utility box 32 is configured to be secured to a bottom or B-side surface of the gaming table. Unless otherwise noted, utility box and drop box may be used interchangeably. When a player wishes to “buy in” to a game or purchase gaming chips at a table game, the player can place currency or paperwork on the top surface 5 of the gaming table 10. The dealer then collects the currency or paperwork, prepares a suitable quantity and type of gaming chips from the chip tray 18 and delivers the chips to the player. The dealer places the currency or paperwork from the player into the drop box 32 by passing the currency or paperwork through the slot 22 in the table 10. The dealer may push the currency or paperwork into the drop box 32 by inserting a paddle or plunger into the slot 22 to ensure the currency or paperwork is properly pushed into the drop box 32. The drop box 32 is typically locked and only authorized personnel, such as casino management or security staff, can access the contents inside of the drop box 32.

A TITO printer 34 may be provided at or adjacent to the gaming table 10. A TITO printer 34 may be configured to print tickets (e.g., TITO tickets) when a player chooses to cash out. A TITO ticket is a printed paper voucher (can be about the size of a receipt) that represents a cash value that can be exchanged for currency or gaming chips or rendered at a slot machine.

In some embodiments, the multifunctional keypad 100 may be configured to communicate with a TITO (Ticket-In, Ticket-Out) printer that is located remotely from the gaming table 10, such as at a centralized printing station within the casino. In this configuration, when the dealer inputs a request for a ticket via the keypad 100, the request is transmitted to the central TITO printer through the table monitoring system 50 or casino network. The printer then generates the requested TITO ticket or voucher at the centralized location. A supervisor, pit boss, or other authorized staff member may retrieve the printed ticket from the central station and deliver it to the dealer at the table 10. This arrangement may be advantageous in casinos where it is desirable to reduce clutter at the gaming table, reduce the number of individual printers required to be printed and installed at the casino, consolidate printing hardware in a central or location, or provide additional oversight by ensuring that supervisors are involved in the delivery of certain tickets or transactions.

A faceplate or frame 30 may surround the slot 22. A traditional faceplate or frame 30 may be a rectangular, square, circular, oval, etc. piece of plastic or metal material that surrounds the slot 22 to provide a finished look at the upper gaming surface 5 of the table 10 in the drop box slot area. A typical frame 30 typically includes no buttons, screens, lights, or other features or structure for a dealer or casino to communicate or interact with.

In some configurations, a gaming table 10 may omit such a faceplate or frame 30. Instead, the top surface of the gaming table 10 has one or more openings or slots.

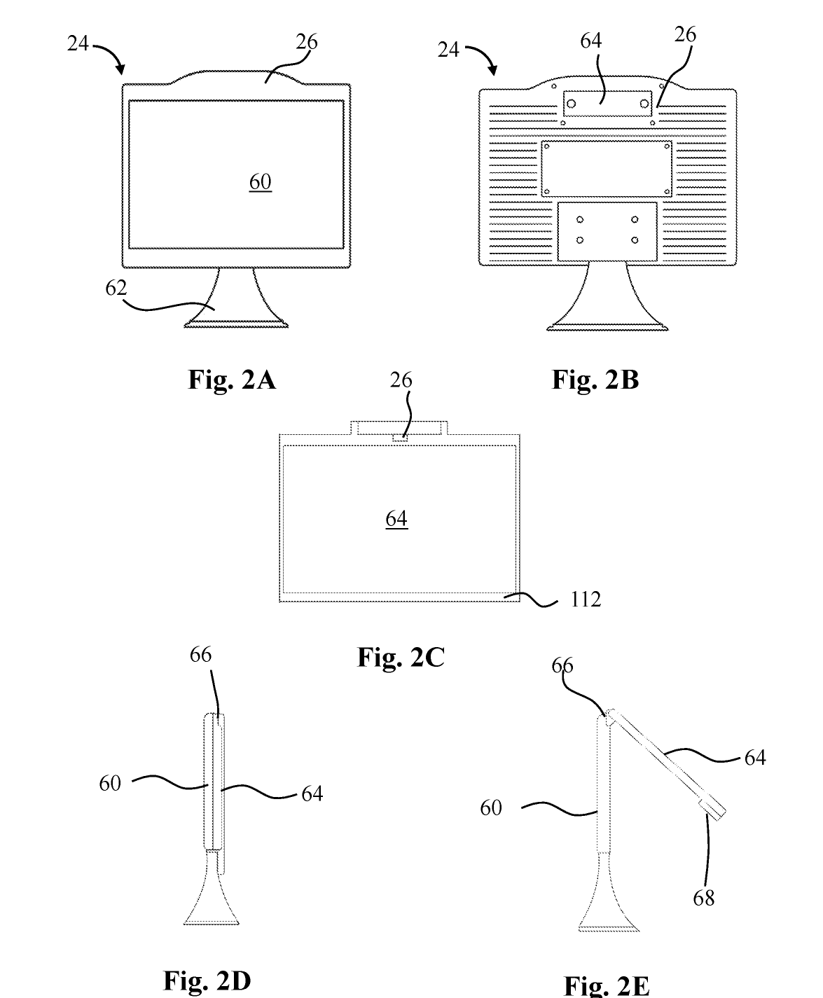

FIGS. 2A-2E illustrate an example of a table sign 24. The sign 24 may be positioned at or adjacent to the gaming table. The sign 24 may be used for displaying and communicating information to one or more dealers and/or casino patrons related to the game name, rules of the game, and/or minimum and maximum wagering amounts. The sign 24 may also be used by casino staff to change information that is displayed on the front facing screen to casino patrons and/or input patron information into a player rating system. The sign 24 may be used for communicating information to the dealer (e.g., via the back side of the sign or display).

The sign 24 may comprise one or more front screens 60. A front screen 60 may be oriented toward the player area 12 and casino patrons and may function as a display for presenting information to players and prospective players. The front screen 60 may communicate game-related information such as the game name, rules of play, and/or minimum and maximum wagering amounts. In addition, the front screen may be configured to present performance metrics relating to the game and/or dealer, including, for example, dealing speed (e.g., hands per hour), winning or losing streaks, or maximum wins within a defined time period (e.g., last shuffle, last hour, etc.). In some embodiments, the front screen may further display dealer-related information, such as the dealer’s name, hobbies, or personal interests, which may encourage player engagement and comfort by highlighting areas of commonality (e.g., a dealer and player sharing an interest in fishing, or the dealer being fluent in a foreign language spoken by a player). Such information may be displayed on the table sign or front screen based on data input directly by the dealer into the multifunctional keypad 100.

The sign 24 may further include one or more rear screens 64. A rear screen 64 may be oriented away from casino patrons and toward the dealer area 14 and casino personnel, such as the dealer, pit boss, or supervisor. In some embodiments, the rear screen 64 may be fixedly attached to the base and/or front screen, such that the rear screen cannot be removed or separated from the base or front screen without damage to one or more of those components. In some embodiments, the rear screen 64 may be removably attached to the base and/or front screen, such that the rear screen can be removed or separated from the base or front screen without damage to one or more of those components. The rear screen 64 may function as a communication or output device configured to display information or dealer alerts for viewing in real time by the dealer or casino personnel. By way of example, the dealer alerts may convey dealer performance metrics, which may include, without limitation: an aggregate number of hands dealt per time interval; a rolling average of hands dealt by the dealer; an indication of whether the rolling average is above or below a predetermined threshold; a number of winning and/or losing hands dealt; and/or a number of hands dealt since a last card shuffle.

In other configurations, the rear screen 64 can be separated from the front screen (See e.g., FIG. 2C). This portability or modularity may provide a dealer and/or pit boss with the ability to comfortably interact with the monitoring and/or processing system 50 and/or the front screen. The front and/or rear screen 64 or rear part of the sign 24 may include one or more cameras or display devices. The one or more rear cameras may be configured for monitoring casino staff and/or players including the dealer or supervisor and/or activity taking place behind the table 10.

The sign 24 comprises one or more hinges 66. The one or more hinges 66 are configured to enable the rear screen 64 to move or pivot between a stowed position (FIG. 2d) and a pivoted position (FIG. 2E). The ability to pivot the rear screen 64 may advantageously provide ergonomic flexibility to the casino operators and staff, especially in low light conditions and/or depending on the height of the sign 24 relative to the casino staff. This may also make the sign 24 easier to read and manipulate if the casino staff of dealer is sitting vs. standing, etc. The one or more hinges may provide for the front and/or rear screen to pivot up and down like shown in the figures and/or side to side to optimally orient the front and/or rear screen in a desired position or direction.

The sign 24 may include one or more detection devices 26. The one or more detection devices 26 may be one or more cameras. The one or more cameras 26 may be utilized by the monitoring and/or processing system 50 for monitoring casino patrons, table game play, table gaming elements (e.g., cards, chips, dice, etc.) casino staff including the dealer, or any combination thereof. The sign 24 may include a base or stand 62 for supporting and/or attaching the sign 100 at the casino table or other areas within the casino.

The sign 24 may include one or more peripherals 68. A peripheral 68 may be or may include one or more devices for a casino staff or dealer to manage, monitor, and/or interact with the table game. For example, a peripheral may be or may include one or more card readers, finger print readers, communication ports (e.g., USB ports), or any combination thereof. A peripheral 68 may be part of the rear screen 64 (e.g., added to the frame or housing of the rear screen) so that when the rear screen 64 is in the pivoted position (FIG. 2E) and/or separated from the front screen or base (FIG. 2C), the peripheral 64 is still accessible to the casino staff or dealer. Advantageously, this allows the casino staff or dealer to easily access the peripheral without having to search for the peripheral in the event the peripheral was located on the base in a region that would be obstructed by the rear screen 108 when the rear screen is pivoted upwardly.

As discussed herein, a gaming table 10 may have more than one sign 24. In some instances, two signs 24 or screens may be connected to the monitoring and/or processing system 50 or controller board thereof independently or daisy chained through each other or via a USB hub. The option for a third sign or screen may be utilized for a casino operator to manage the player rating system. This dedicated monitor or screen may connect directly to the monitoring and/or processing system 50.

Two or more signs 24 may be used at a gaming table 10 where analytics take place. A single sign 24 embedded with cameras or detection device 26 might be used to analyze the gaming table 10 using deep learning methodologies. Such methodologies might determine the value of chips being wagered, the cards being played, and the pace of the game. The controller device 50 may also have a neural processing unit installed. Connecting more than one sign or screens allows for a reduction in blockages due to hands, stacks of chips, and other items, preventing accurate analysis. The sign 24 embedded with a camera or cameras 26 might be connected within the sign 24 via a hub type device allowing for data transmission using numerous peripherals over a single connection. The sign may operate as a mirrored sign or as an independent sign. It is also possible that each sign 24 has numerous cameras 26 for different zoom and/or focus levels for various regions of interest such as cards/chips or faces/arms/hands.

FIGS. 3 and 4 illustrate an example of a multifunctional keypad 100 for a gaming table at a casino. It is envisioned that the multifunctional keypad 100 according to these teachings can replace a traditional faceplate or frame 30 that typically surrounds one or more drop box slots slot 22 on the table top 5 (FIG. 1). Additionally, or alternatively, it is envisioned that the multifunctional keypad 100 according to these teachings can be placed over any existing traditional faceplate or frame 30 that typically surrounds one or more drop box slots slot 22. A traditional faceplate or frame 30 may be typically just a piece of material that surrounds the slot to give the table a finished look and include no buttons, screens, or other interactive features for the dealers to communicate or interact with. Advantageously, this may provide for a more straight forward and less complicated way to install the multifunctional keypad 100 at the gaming table.

It is envisioned that the multifunctional keypad 100 according to these teachings can consolidate two or more standalone or ancillary devices that are typically used by a casino dealer and located at a casino gaming table into a single device. Advantageously, the multifunctional keypad 100 according to these teachings may reduce clutter and/or distraction at a gaming table and/or improve or streamline dealer operations at the gaming table. These and other benefits of the multifunctional keypad 100 will be gleaned by a person having skill in the art from the teachings herein.

The multifunctional keypad 100 according to these teachings may also be referred to herein as a keypad, faceplate, and/or multifunctional faceplate, multifunctional device, dealer interface device, gaming table input device, etc. without limitation.

The multifunctional keypad 100 may be installed on top of or over the upper gaming surface 5 of the gaming table 10 (FIG. 1) and in a region that is generally over the drop box slot 22 defined in the gaming table 10. In this regard, before the keypad 100 is installed on the gaming surface 5 of the gaming table 10, any existing frames 30 located on the gaming table that surround the drop box slot 22 should be removed or separated from the gaming table 10. This may be done by removing one or more of the attachment or fastening devices used to secure the frame 30 to the gaming table 10.

In other configurations, depending on the size and shape of the frame 30, the frame 30 that surrounds the existing drop box slot 22 in the gaming table need not be separated or removed from the gaming table 10 before the keypad 100 is installed on the gaming table 10. Instead, the back or B-side of the keypad 100 may comprise one or more recesses, notches, depressions or grooves that may be sized, dimensioned, and configured to accommodate an existing frame 30 that is installed on the upper gaming surface and on top of the frame or cover the frame so the multifunctional keypad 100 can be positioned over or on the existing frame 30 and drop box slot 22 without having to remove the frame 30 and while still providing a substantially flush look and feel on the upper gaming surface 5. Advantageously, this may streamline and reduce time to install the multifunctional keypad 100 and/or retrofit the keypad 100 onto existing gaming tables 10.

The multifunctional keypad 100 comprises one or more attachment devices 101 for attaching or securing the multifunctional keypad 100 to the gaming table 10. The one or more attachment devices 101 may engage the upper gaming surface 5 of the gaming table 10 and/or an existing frame 30 surrounding the drop box slot 22, if the frame 30 is not removed from the gaming table 10 before installing the multifunctional keypad 100. The one or more attachment devices 101 may be one or more screws, tape, double sided tape, adhesive, clips, prongs, protuberances, snaps, pins, hook and loop fasteners, etc. that are suitable to attach and secure the multifunctional keypad 100 to the gaming table 10 and/or existing frame 30. The one or more attachment devices 101 may be located or accessed at/from the top or A-surface of the multifunctional keypad 100, located or accessed at/from the back or B-surface of the multifunctional keypad 100, or both. In some configurations, the one or more attachment devices 101 may be accessed from beneath or below the gaming table 10 and extend upwardly through the table and into the keypad 100. The one or more attachment devices 101 may be located in some or all of the corners of the rectangular keypad 100. In other configurations, one or more attachment devices that attach or secure the frame 30 to the gaming table 10 can be repurposed to secure the keypad 100 to the gaming table 10 and/or frame 30.

The multifunctional keypad 100 comprises one or more electronic devices or processing units (PU) 111. The one or more processing units 111 may include, without limitation, a microprocessor, microcontroller, digital signal processor (DSP), field-programmable gate array (FPGA), application-specific integrated circuit (ASIC), or other suitable computing element. The processing units 111 may be operatively coupled to one or more memories, such as random-access memory (RAM), read-only memory (ROM), flash memory, or other non-transitory computer-readable storage media, configured to store instructions, algorithms, and data for execution and retrieval. The multifunctional keypad 100 may further comprise one or more power supplies, voltage regulators, or power management circuits configured to provide electrical power to the processing units and associated components.

In certain embodiments, the processing unit 111 may be connected to one or more communication interfaces, such as universal serial bus (USB) ports, Ethernet interfaces, wireless transceivers (e.g., Wi-Fi, Bluetooth, ZigBee), radio-frequency (RF) modules, or serial communication buses (e.g., SPI, I²C, UART), thereby enabling data transfer between the keypad 100 and external devices, networks, or monitoring systems. Additional hardware may include input/output (I/O) devices such as key switches, touch sensors, or card/ticket readers, and output devices such as light-emitting diode (LED) indicators, liquid-crystal displays (LCDs), or speakers. Collectively, the hardware components of the multifunctional keypad 100 are configured to execute software instructions, implement algorithms, and perform the functions disclosed herein in a manner tied to concrete technological components.

The one or more electronics devices or processing units (PU) 111 may be electrically connected to the table or game monitoring system 50, power source, detection devices, etc. via one or more power and/or communication devices 103. The one or more power and/or communication devices 103 may be configured to send and/or receive (e.g., 1-way or 2-way) data, power, dealer alerts, dealer information, or a combination thereof to, from, or between the keypad 100 (e.g., the one or more electronics devices or processing units (PU) 111) and the table monitoring system 50.

A power and/or communication device 103 may be one or more wired or wireless devices that are configured to electrically connect or communicate power to/between the one or more electrical components of the multifunctional keypad 100, like the PU, from a power source such as a battery, wall outlet, or computer and/or the table monitoring system 50. A power and/or communication device 103 may be configured to communicate power, signals, and/or data to, from, and/or between the electrical elements of the multifunctional keypad 100, like the PU and one or more other electrical devices, such as a computing device like a server, processor, computer, and/or sign 24 located at or adjacent to the gaming table 10; a table monitoring system 50; or any combination thereof. The one or more power and/or communication devices 103 may be one or more plugs, wires, ports, cables like ethernet or USB cables, antennas, RFID transmitter and/or receiver (e.g., electromagnetic induction), BLUETOOTH transmitter and/or receiver, ultra-wide band communication devices (anchor and/or beacon), or any combination thereof.

During installation of the multifunctional keypad 100 at the gaming table 10, the one or more power and/or communication devices 103 may be routed into and through the drop box slot 22 to an appropriate electrical device, like a power and/or communication device or router for ultimate communication with the table management system 50. In other configurations, the one or more power and/or communication devices 103 may be routed or received into one or more other bores or other apertures that are specifically formed in the gaming table 10 and/or preexisting bores or apertures to connect to an appropriate electrical device. The one or more power and/or communication devices 103 may be routed under the table and connect to an appropriate electrical device. In some configurations, one or more power and/or communication devices 103 may be routed through the slot 22 and into the drop box 30 and connected to an appropriate electrical device located inside the drop box 30 and/or adjacent to the drop box 30.

An electrical device with which the one or more electronic devices or processing units (PU) 111 may communicate via the one or more power and/or communication devices 103 may include, without limitation, a computer, processor, server, edge server, router, modem, TITO printer, table monitoring system 50, machine learning model, deep learning model, algorithm, look-up table, controller, microcontroller, hub, or any combination thereof. The electrical device may comprise a physical device located on or adjacent to the gaming table, elsewhere within the casino facility, and/or remotely via a network or cloud-based infrastructure. In some embodiments, the electrical device may comprise a local or distributed table monitoring system 50 and/or casino surveillance system. In certain implementations, the electrical device may include hardware-implemented artificial intelligence or machine learning accelerators (e.g., GPUs, TPUs, or dedicated inference processors) configured to execute models and algorithms for dealer performance tracking, chip recognition, or player interaction analysis.

By way of example, the table monitoring system 50 and/or surveillance system may be of the type illustrated and described in commonly owned U.S. Patent Application No. 18/884,502, filed September 13, 2024, which claims priority to U.S. Provisional Patent Application No. 63/582,281, filed September 13, 2023, the entireties of which are hereby incorporated by reference for all purposes.

Additionally, or alternatively, the multifunctional keypad 100 may communicate, either wirelessly and/or through a wired connection, with one or more displays or table signs 24 positioned at or near the gaming table 10. Such table signs 24 are also disclosed in the above-referenced U.S. patent applications incorporated herein by reference. In certain embodiments, information corresponding to data entered by a casino dealer into the multifunctional keypad 100 and/or obtained by the multifunctional keypad 100 from an external source, such as the table monitoring system 50, may be presented on the table sign 24 for viewing by one or more players and/or casino personnel. By enabling communication between the keypad 100 and the table sign 24, a dealer may input and control information at the keypad faceplate while a supervisor or casino management may simultaneously monitor activity or provide approvals via the table sign without interrupting the dealer’s operation of the table.

As discussed, the table sign 24 may include both a front screen and a rear screen. The front screen may be oriented toward the players and configured to display information such as wagering limits, promotional or advertising content, game progress, player rewards, or statistical information (e.g., winning streaks). The rear screen may be oriented toward the dealer and/or casino personnel and configured to display operational data or analytics, including, for example, the number of hands dealt by the dealer, the dealer’s performance metrics, or player-specific information such as loyalty status, wagering history, or betting behavior. In this manner, the table sign functions as a dual-purpose communication device providing targeted information to both players and casino staff. An exemplary casino gaming table sign 24 is disclosed in US 29/970,698 filed on October 30, 2024 the entirety of which is incorporated by reference herein for all purposes.

A casino gaming table sign 24 may have a front screen that faces the player area 12 side of the gaming table 10 and is configured to provide information to players and/or casino patrons. By enabling an electronic communication link or signal between the multifunctional keypad 100 and the table sign 24, a dealer can input and/or control information via the keypad 100 for display on the sign facing the player area 12 to be viewed by one or more players and/or casino patrons. Additionally or alternatively, the table monitoring system 50 can obtain data or information from the keypad 100 for display on the table sign 24 to players and/or patrons. For example, data or information displayed on the table sign 24 may include bet amounts, advertisements, winning streaks, payouts, # of winning hands dealt the dealer within a predetermined time period, progressive jackpot amounts, etc.

In some configurations, the one or more signs 24 may have a rear screen that faces the dealer area 14 or pit surveillance area. By enabling an electronic communication link or signal between the multifunctional keypad 100 and the table sign 24, a dealer can input and/or control information via the keypad 100 for display on the sign facing the dealer area 14 to be viewed by one or more casino staff or supervisors. Additionally or alternatively, the table monitoring system 50 can obtain data or information from the keypad 100 for display on the table sign 24 to casino staff or managers. For example, data or information displayed on the table sign 24 may include bet amounts, player ratings, # of hands dealt, time until next break or shift change, bet amounts by players, buy in amounts by players, time when a player sits down at the table, time when a player leaves the table, amount of gaming chips, winnings, or losses a player currently has, information about a player (loyalty information, betting amounts, etc.) etc.

The keypad 100 may include one or more keypad slots 102. In other words, the keypad 100 itself comprises one or more apertures or pass throughs or absence of material. A keypad slot 102 may be an opening, aperture, port, pass through, or other orifice defined in the structure of the keypad 100. The slot 102 may be dimensioned, arranged, and configured to generally align with one or more slots 22 or other openings, apertures, and/or other orifices in the gaming table 10. One or more items, such as currency, gaming chips, slot tickets, TITO tickets, paperwork, etc., can be passed into and through the one or more slots 102 into a location below the table, such as into a drop or utility box 32 (FIG. 1). A dealer or casino personnel may use a paddle or plunger to force, push, or move the currency, gaming chips, paperwork, etc. through the keypad slot 102 and into the corresponding receptacle.

The one or more or more slots in the keypad 100 (slot 102 or another slot in the keypad 100, such as slot 113 in FIG. 2) may be configured to dispense and present one or more items to a dealer or casino staff at the top surface of the gaming table. For example, the one or more items may be one or more receipts, couches, TITO tickets (Ticket In, Ticket Out). A ticket or voucher device, such as a printer or TITO printer 34 (FIG. 1), may be arranged adjacent to or under the gaming table 10 and a printed receipt, voucher, or TITO ticket can be presented to the dealer through the one or more slots 102, 113 in the keypad. In such a configuration, the slot 102113 may also be referred to herein as a ticket slot or TITO slot.

In typical configurations, a TITO printer may be provided adjacent to the gaming table 10, and the printed ticket may be presented to the dealer in a location that is away from the gaming table. Again, such a typical configuration adds clutter to the gaming table 10 and provides the appearance that the TITO printer was added to the gaming table as an afterthought. By integrating and dispensing or preventing the TITO ticket through a slot in the keypad 100, a minimalistic and clutter free gaming table is presented to the dealer and player.

The ticket slot through which the TITO ticket can be dispensed from may be the same slot (e.g., slot 102) that is used to pass currency, gaming chips, paperwork, etc. into a drop box, or the ticket slot may be a different slot than the drop box slot. For example, a TITO or ticket slot 113 may be arranged within the drop box slot 102 or vice versa. In other words, the one or more drop box slots 113 and the one or more ticket slots 102 are the same slot. A door, wall, channel, flap or divider may be provided in the keypad slot 102, 113 so that any currency, gaming chips, or paperwork that is inserted into the slot and intended to be received into the drop or utility box 32 does not interfere with any tickets that are printed by the printer 34 and presented to the dealer via the slot.

In other configurations, the ticket slot 113 may be a separate and discrete slot or opening from the slot 102 that is used to insert currency or paperwork into the drop box 34.

The tickets, receipt, voucher, TITO tickets, etc. may print from a printer or ticket printing machine that is below the gaming table 10 (preferably out of sight from the dealer and/or players) and present the ticket vertically upwards from or through the ticket slot 102113. In other words, the TITO ticket may be substantially vertically oriented relative to the gaming table top or gaming surface 5 of the gaming table 10 when it breaks the plane of the gaming table and is exposed to the dealer. In other configurations, the TITO ticket may be printed and presented to the dealer at an angle relative to the table top. Advantageously, by presenting the TITO ticket at the gaming table, the dealer, player, and casino surveillance (watching live and/or via the one or more detection devices 26, 28 and/or system 50) can see the TITO ticket printed.

A dealer or casino personnel may utilize one or more buttons or input devices 105 described further below to input information into the keypad 100 and control a TITO printer to print TITO tickets or receipts that are then presented to the dealer through a slot in the keypad 100.

The keypad 100 may include one or more input devices 105. An input device 105 may be any component that allows a dealer or other casino personnel (e.g., a pit boss, manager, surveillance staff, or technician) to interact with the keypad 100 to enter information or commands. By way of example, the input device 105 may comprise a touchscreen, liquid crystal display (LCD) with touch input, resistive or capacitive touch overlays, discrete mechanical buttons, alphanumeric or numeric keypads, symbol or function keys, rotary knobs, dials, rocker switches, toggle switches, or other manually actuated elements. In some embodiments, the input device 105 may further include microphones configured to receive audio input, gesture sensors or cameras configured to detect hand movements, biometric readers (e.g., fingerprint or palm recognition), or contactless input technologies (e.g., RFID or NFC readers for dealer/player identification). An input device may be a barcode reader, scanner, thumb print reader, camera, or other detection device disclosed herein.

Input received through the input device 105 may be electrically communicated from the keypad 100 to one or more external systems, such as the table monitoring system 50, a surveillance system, and/or one or more table signs 24, via operative interaction between the electronic device 111 and the communication device 103. The communicated information may be used for analysis, data processing, authentication, approval workflows, information storage, or a combination thereof.

For example, a dealer may input information or data into the keypad 100 via the one or more input devices corresponding to player information, actual or average bet amounts, when a player arrives at the table, when a player departs the table, how much a player has won or lost, etc. Via the input device 105, a dealer may request assistance from casino management or security staff, request assistance from casino hospitality, receive messages or notifications from casino management or staff or from the table monitoring system 50, redeem and print vouchers, TITO (Ticket In, Ticket Out) tickets, change the gaming table to an active status, inactive status, open table, close table, etc. or any combination thereof.

For example, if a dealer needs assistance from a supervisor, surveillance, etc., then the dealer may use one or more of the input devices 105 to notify or call the appropriate personnel. For example, if a player requests a beverage or snack, then the dealer may call or request assistance from hospitality, a server or waiter/waitress, etc. via one or more input devise 105. If a player seeks medical attention or wishes to dispute game play that has or is taken place, then the dealer may call appropriate personnel via the one or more input devices 105.

The keypad 100 may further include one or more output devices 107. An output device 107 may comprise any telltale, alert mechanism, or display element configured to communicate information to the dealer and/or other casino personnel. The output device 107 may be implemented in various forms, including but not limited to light-emitting diodes (LEDs), liquid crystal displays (LCDs), touchscreens, graphical user interfaces (GUIs), speakers, haptic feedback mechanisms (e.g., vibration motors), or a combination thereof. In this manner, the output device 107 enables real-time communication of operational and performance-related information directly to the dealer or casino personnel.

Information communicated or displayed on the one or more output device may be or relate to, without limitation, game particulars such as game rules, minimum and/or maximum buy-in amounts, and payout amounts to players. In some embodiments, the output device 107 may provide alerts regarding detected errors during gameplay, identification of one or more players at the table, or reminders relating to dealer activity, such as the time remaining in a shift or the current time of day. Additional examples of output information may include dealer performance metrics, notifications from casino management (e.g., approvals or instructions), system diagnostics, connectivity status, or security alerts.

An output device 107 may also or may instead be configured to provide a data, message, or notification output to another device, such as a mobile device (tablet, phone, etc.). This may allow a dealer, supervisor, or other casino staff to be made aware of certain messages, data, or information, in addition to being notified via the keypad 100.

A display 104 on the keypad 100 and/or one or more output devices 107 on the keypad 100 may be configured to communicate dealer alerts or other information to inform the dealer of past and/or present performance metrics. In certain embodiments, such performance metrics may be obtained from the table monitoring system 50, which monitors, observes, and/or calculates gameplay at the gaming table 10 via one or more detection devices 26, 28. The performance metrics may include, without limitation, the number of hands dealt within a defined time interval (e.g., during the last hour or dealer shift), the number of winning and/or losing hands dealt within a defined time interval (e.g., within the last hour, ten minutes, or shift), a rolling average of hands dealt per time interval, the number of hands dealt since a last shuffle, the number of hands dealt during a previous session prior to a break, the current time of day, or an indication of time remaining in a dealer’s shift or time until the dealer’s next break. In some embodiments, the keypad 100 may further provide a payout calculator configured to assist the dealer in determining appropriate payout amounts for particular wins.

For a Roulette table, feedback provided to the dealer may include, for example, the number of spins within a defined time period, payout calculations, or a “spin now” indicator prompting the dealer when to spin the wheel. Other embodiments may provide alerts relating to compliance metrics, procedural reminders, or system-generated efficiency targets. By presenting such information directly on the keypad 100, the dealer is able to remain aware of performance metrics and adjust their dealing style or speed as needed to meet, maintain, or exceed defined performance goals, without distracting the players at the table or requiring a pause in gameplay for supervisory intervention.

More specifically, the table monitoring system 50 may comprise a processor and a memory storing rules for calculating game play activity at the gaming table based on gameplay data received from one or more detection devices 26 that are provided at or adjacent to the gaming table 10. The processor may be configured to receive the gameplay data from the one or more detection devices 26, timestamp the gameplay data, and generate game play performance data for metrics. For example, the processor may obtain and aggregate hands dealt per time interval, compute a rolling average, compare the rolling average to a threshold, and generate a dealer alert. The dealer alert can then be provided to an output device 107 on the keypad for the dealer to see in real time during game play at the gaming table 10. For example, the dealer alert may convey dealer performance metrics including one or more of: (a) the aggregate number of hands dealt per time interval; (b) a rolling average of hands dealt by the dealer; (c) whether the rolling average is above or below a threshold; (d) a number of winning hands and/or losing hands dealt by the dealer; and (e) a number of hands dealt by the dealer since a last card shuffle. The dealer alert may be provided to the dealer on the keypad in real time, or within a slight lag (e.g., within 2 seconds or less than 2 seconds), so the dealer can be fully made aware of their performance and adjust their performance if necessary (e.g., fi the performance level or metric is below a determined threshold).

In some embodiments, a dealer alert may further comprise dealer assistance information generated to assist the dealer during gameplay. Such dealer assistance information may include, without limitation: (a) a number of hands dealt by the dealer since a last card shuffle; (b) a number of hands carried over from a previous dealing session prior to a dealer break; (c) an amount of time remaining in the dealer’s shift or until a next scheduled break; (d) an indication of an error detected during gameplay based on gameplay data processed by the processor; (e) a payout value calculated by the processor to assist the dealer in determining how much to pay a player for a winning outcome; (f) rules of the game relevant to an actual outcome; and/or (g) processor-generated instructions for guiding the dealer in resolving a discrepancy with a player. The processor of the table monitoring system 50 may be configured to receive gameplay data from one or more detection devices 26 and apply the data to one or more rules, algorithms, look-up tables, statistical models, or artificial intelligence techniques (e.g., machine learning and/or deep learning) to generate such dealer assistance information. In some embodiments, the processor may process the gameplay data to generate a predicted game outcome, compare the predicted game outcome to an actual game outcome, and then generate corresponding dealer assistance information in real time. The provision of such dealer alerts enables the dealer to maintain awareness of performance, accelerate gameplay, resolve disputes, use the system as a training tool, and improve the overall integrity of the game.

In some embodiments, a dealer alert may convey player-related information to the dealer in real time on the keypad 100. Such information may be retrieved by the processor of the table monitoring system 50 from a player database associated with the monitoring system. By way of example, the player-related information may include whether a player has previously presented a loyalty card or other identifying information to the casino; the player’s historical win/loss record; medical or accessibility conditions relevant to gameplay; food and beverage preferences; or personal interests and hobbies that may facilitate rapport or conversational engagement between the dealer and the player.

The dealer alert may further convey player status information retrieved from the player database, such as whether the player has been identified by the casino or the monitoring system as an advantage player. Additionally, the dealer alert may provide player restriction information indicating whether the player has been designated as a restricted or banned player. Such information may be presented on the keypad 100 in real time, enabling the dealer to remain aware of player status, improve customer interaction, and ensure compliance with casino policies

The table or game monitoring system 50, keypad 100, or a processor thereof, may be configured to calculate a dealer score representing the performance of a dealer during gameplay. In certain embodiments, the dealer score may comprise a weighted average that takes into account one or more performance criteria and may be referred to as a Weighted Average Dealer Score (WADS). The WADS may quantify and reflect the performance of an individual dealer over a defined time period, such as a gaming session, dealer shift, day, or week. In some implementations, the WADS may be calculated as a rolling or dynamically updated value that is revised with each hand dealt, each game outcome, or other gameplay activity, thereby ensuring the score remains current and reflective of the dealer’s most recent performance. The calculation may be performed by one or more processors that are part of the system 50, are located at the gaming table (e.g., an edge server or processor), a processor that that is located in the surveillance or other room at the casino, by a server in the cloud, or a server that is located in another building.

The WADS may be computed by the table or game monitoring system 50, or the processor thereof, as a weighted average of various activity-based metrics collected by the monitoring system. Such metrics may include, by way of example and without limitation: the aggregate number of hands dealt per time interval; a rolling average of hands dealt; whether the rolling average is above or below a predetermined threshold; the number of winning and/or losing hands dealt by the dealer; the number of hands dealt since a last card shuffle; average shuffle time (manual or automatic); the number and/or duration of breaks taken by the dealer; table downtime attributable to the dealer; and the number or percentage of error-free rounds.

Accordingly, the processor of the table or game monitoring system or keypad may be configured to calculate a dealer score, the dealer score comprising a Weighted Average Dealer Score (WADS) that is determined as a weighted average of one or more dealer performance criteria, the performance criteria including at least one of: a number of hands dealt per defined time interval, a rolling average of hands dealt by the dealer, whether the rolling average is above or below a predetermined threshold, a number of winning and/or losing hands dealt, or a number of hands dealt since a last card shuffle. The WADS is calculated as a rolling value that is dynamically updated based on gameplay activity to reflect the dealer’s most recent performance.

To provide fair comparisons among different dealers, particularly across varying game types and table conditions, the WADS computation may incorporate performance modifiers or considerations that normalize dealer activity for table complexity and external factors.

Such modifiers or considerations may include, without limitation: amount of cards dealt per player position; decision process of the players (e.g., time to decide, effectiveness of decisions), number of side wagers placed and payouts for side wagers, payouts per position, staging time between rounds of cards being dealt, errors occurred, transactions processed during or after the round, transaction speeds factoring in outside factors such as time for supervisor approval or other requirements (mobile transfer/etc.).

Such modifiers or considerations may include, without limitation: gameplay and table flow factors: the number of cards dealt per player position; the decision-making process of players (which may affect round duration); staging time between consecutive rounds; table occupancy levels (active versus empty seats); and game type complexity (e.g., blackjack versus baccarat versus poker). Such modifiers may include, without limitation: Side wager and payout factors: the number of side wagers placed and the percentage of players engaging in such wagers; side-bet revenue attributable to the dealer’s promotion of side wagers; payout accuracy for side wagers; payout accuracy per position; and overall payout accuracy across rounds.

Such modifiers or considerations may include, without limitation: error and compliance factors: an error count and associated error severity (e.g., incorrect payout versus regulatory violation); the number of compliance checks performed (e.g., player ID verification); compliance with house procedures (e.g., proper gestures, card exposure, table taps, etc.); and events flagged by detection devices (e.g., misdeals, improper payouts). Such modifiers may include, without limitation: Transaction and financial handling factors: the number and type of transactions processed during or after a round (e.g., buy-ins, cash-outs); transaction speeds net of delays caused by supervisor approvals, mobile transfers, or procedural holds; chip tray reconciliation accuracy (e.g., end-of-shift reconciliation versus expected amounts); and net player buy-ins versus walk-aways (e.g., whether more players left winning or losing money).

Such modifiers or considerations may include, without limitation: player interaction and satisfaction factors: player retention time (how long players remain at the table during the dealer’s shift); tips received per hour (as an indicator of player satisfaction); loyalty program engagement (e.g., number of new players registered); and player survey or feedback ratings. Such modifiers may include, without limitation: Operational and environmental factors: dealer transitions (e.g., resuming after a break, starting a shift, or handling a dealer swap); the frequency of supervisor interventions; table downtime attributable to the dealer; efficiency in handling comps or player ratings; external conditions outside the dealer’s control (e.g., noise, disruptions, power outages); time of day, day of the week, holidays, or special events (e.g., concerts, sporting events).

Such modifiers or considerations may include, without limitation: experience factors: dealer seniority (e.g., number of years employed as a dealer or in the gaming industry).

In some instances, a dealer may be incentivized to reduce their deal rate (e.g., slow down their hands per hour) in order to cater to and/or train less experienced players. Such a performance modifier may also be considered in the WADS score so the dealer is not penalized for dealing slowly in instances where they are specifically asked by a player or by casino staff to slow down their pace.

One or more of these performance modifiers or considerations may have a positive, negative, or neutral effect on the WADS score and may be directly attributed to the performance of a particular dealer or staff member.

The resulting WADS score may be applied in multiple operational contexts. For example, the score may be used to provide real-time dealer alerts (e.g., via keypad output devices 107) when performance exceeds a threshold or falls below acceptable levels. The WADS may also be used to rank individual staff members for awards or recognition, identify underperforming staff who may require training, coaching, or reassignment, and support human-resource functions such as promotions or hiring decisions. In certain embodiments, the WADS score may be standardized across multiple casinos to enable consistent screening and ranking of dealers for employment, recognition, bonuses, pay increase, or competitive purposes.

In some embodiments, the WADS score may also be communicated to casino patrons and players. For example, the WADS score may be displayed on a front-facing screen of a table sign or other display device positioned at or adjacent to the gaming table. In this manner, existing players or prospective players approaching the table may view the dealer’s WADS score in real time. The availability of the WADS score to players may operate similarly to a rating system used in restaurants or other service venues, where the score serves as an indicator of the quality or efficiency of service. Players may choose to participate in games at tables having a WADS score above a certain threshold, thereby promoting competition among dealers to maintain or improve their performance. The visibility of the WADS score to players may further incentivize dealers to maximize their performance, since a higher score may attract more players to their table. Increased patronage may, in turn, result in greater opportunities for tips, recognition, awards, or eligibility for salary adjustments or promotions. Thus, the display of the WADS score provides not only operational benefits to the casino in managing dealer performance, but also motivational benefits to dealers, reinforcing a cycle of improved service and enhanced player engagement.

In other embodiments, only certain dealer performance data may be displayed or made visible to the players or perspective players on the front screen of the sign 24. That is, the WADS score may not be displayed, but other relevant information may be displayed that may assist or incentivize a player to play at the table such as pace or hands per hour, win/loss streak, etc. An experienced player may wish to engage a dealer who deals quickly vs an inexperienced player may wish to engage a dealer who deals more slowly.

Accordingly, a multifunctional keypad 100 for a gaming table at a casino is disclosed. The gaming table comprising an upper gaming surface covered in a felt or fabric material, and located at the upper gaming surface is a chip tray comprising gaming chips, a card shoe comprising playing cards, and one or more betting regions. The multifunctional keypad 100 is configured to be installed on the upper gaming surface and electrically connected to a table monitoring system 50. The table monitoring system 50 comprising a processor and a memory storing executable instructions and/or an algorithm for calculating game play activity at the gaming table based on gameplay data received from one or more detection devices 26 provided at or adjacent to the gaming table. Wherein the processor is configured to: receive and timestamp the gameplay data; compute a Weighted Average Dealer Score (WADS) as a weighted average of dealer activity metrics comprising at least one of: (a) an aggregate number of hands dealt per time interval, (b) a rolling average of hands dealt by the dealer, (c) whether the rolling average is above or below a predetermined threshold, (d) a number of winning and/or losing hands dealt by the dealer, (e) a number of hands dealt by the dealer since a last card shuffle, (f) payout accuracy for wagers, (g) staging time between consecutive rounds of cards being dealt, and (h) an error count or error severity index. The processor may be configured to generate a dealer alert based at least in part on the computed WADS. As disclosed, the multifunctional keypad 100 comprises one or more attachment devices for securing the multifunctional keypad to the upper gaming surface of the gaming table; an electronics device; one or more communication devices electrically connecting the electronics device to the table monitoring system; a slot through which currency and/or paperwork is configured to be passed through the multifunctional keypad and into a drop box or utility box located under the gaming table; one or more input devices electrically connected to the electronics device and accessible to the dealer to input information into the multifunctional keypad and to cause information to be displayed on a table sign positioned at or adjacent to the gaming table and electrically connected to the multifunctional keypad for viewing by one or more players at the gaming table; and one or more output devices electrically connected to the electronics device and accessible to the dealer for communicating the dealer alert, including the WADS, to the dealer in real time during game play. In some configurations, the dealer alert comprising the Weighted Average Dealer Score (WADS) may be communicated to a table sign positioned at or adjacent to the gaming table, the table sign including a front-facing display oriented toward casino patrons such that the WADS score is viewable by players at the gaming table. The WADS score may be viewable in real time, or with a slight delay, for example within one or more preceding rounds.

An output device 107 on the keypad may be an alerting device that is configured as a telltale. The dealer information, alert, or other information may be communicated to the dealer or keypad via an output device 107.

By way of example, an alerting output device 107 or telltale may include, without limitation: a light bulb, light-emitting diode (LED), or other visual indicator; a display message; an audio device such as a speaker configured to generate an audible alert (e.g., a beep, chime, bell, or voice message); and/or a haptic feedback device configured to vibrate. The output device 107 may employ one or more of these modalities individually or in combination to notify the dealer of a dealer alert in real time during gameplay.

The output device 107 may be configured to inform or notify the dealer of a possible error that has been determined or observed during gameplay. The error may be identified by the table monitoring system 50, by one or more detection devices, and/or by casino staff. For example, if it is determined that a dealer collects money from a player after a push, or pays the player more or less than the correct payout, the dealer may be notified of the error via the output device 107 on the keypad 100. Such notification may enable the dealer to rectify the situation promptly, without causing a scene or distracting other players or patrons at or near the table.

In some embodiments, the output or alerting device 107 may comprise a barcode scanner or similar optical scanning device configured to read items such as tickets, player loyalty cards, or identification cards. The light beam of the scanner (e.g., a laser or LED beam) may be repurposed or redirected to function as an alerting mechanism, thereby providing a visual or optical signal to the dealer of one or more actions or events in accordance with the teachings herein. An alerting or output device 107 may be configured to provide a reminder to the dealer such as to request identification from a player at the gaming table. An alerting or output device 107 may be configured to provide a signal to the dealer that the player has already been identified and/or checked in.

When a dealer or the faceplate 100 receives an incoming transaction, using NFC, UWB/BLE, or any possible method, the screen or on the faceplate 100 may display the incoming transaction on both the faceplate 100 and the screen of the sign 24 facing the player area. When the dealer taps the button on the faceplate that the transaction was processed the screens (rear and/or front) may show a successful event. The rear screen if present, might show the details for the transaction for the supervisor to input. It is also possible this information is written directly into the player rating system.

When a new player arrives at the table 10, the dealer may swipe or otherwise present the player’s card to a card reader on the faceplate 100. The system may then retrieve the player’s identifying information (e.g., name) and cause a message or greeting to be displayed on the front, player-facing side of the sign 24. The dealer may subsequently be prompted by the system to input additional information such as the player’s seat number, buy-in details, and/or other transaction data. A timestamp for the player’s arrival may also be generated and stored. This information, together with the card data, may be staged or queued for processing and displayed on the rear screen of the sign 24 and/or on the keypad 100. In some embodiments, the rear screen may provide a visual indicator, such as a pulsing light or color change, to notify a supervisor or pit boss of the pending transaction. Additionally or alternatively, the supervisor or pit boss may be alerted of the pending transaction on a remote device such as a computer, tablet, or monitoring station. At an appropriate time, the supervisor may then arrive at the table and utilize the emulated card data and player play data to complete the transaction by inputting the information into the player rating system.

By staging the player information into a queue, the player may begin or continue gameplay at the table while their play is tracked and potential comps begin accruing, even before the information is formally entered into the player rating system. Advantageously, this arrangement reduces waiting time and increases table game speed, since the dealer and/or player need not pause for a supervisor or pit boss to immediately confirm player information at the table.

In some embodiments, staging the player information into a queue also allows for deferred entry of the data into the player rating system. This may be particularly beneficial in situations where the player rating system does not communicate directly with the keypad, sign, or other peripheral device initially used to capture player information. In such cases, the staged or queued information may later be entered into the player rating system by a supervisor or pit boss through a manual transfer or similar approval process.

Accordingly, a method (or method step) is disclosed that comprises: receiving, at a card reader of a multifunctional keypad positioned on the gaming table, player identification data associated with a player; retrieving, via a processor of a table monitoring system, player information from a database based on the player identification data; displaying a message or greeting corresponding to the player information on a front screen of a table sign oriented toward one or more players; prompting a dealer to input additional player-related data comprising at least one of: a seat number, buy-in information, and transaction details; generating and storing a timestamp corresponding to the player’s arrival at the table; staging, by the processor, the player identification data and the additional player-related data into a queue for later processing; displaying, on a rear screen of the table sign and/or the multifunctional keypad, an indicator of the pending transaction; notifying a supervisor or pit boss of the pending transaction via at least one of: a visual indicator, a color change, a pulsed light on the rear screen, or a message on a remote monitoring device; and allowing the player to begin or continue gameplay while the staged information is queued for later entry into a player rating system by the supervisor or pit boss.

In some configurations, the keypad 100 or an input device 105 thereof may comprise a reconciliation button or feature. The reconciliation feature may enable a dealer to reconcile an error or inconsistency identified during gameplay. The error or inconsistency may be identified by the table monitoring system 50, a player, the dealer, a supervisor, or any combination thereof. In some embodiments, the error or inconsistency may be detected by a processor of the keypad 100 or the table monitoring system 50, which monitors and analyzes gameplay by comparing images, video, or data received from one or more detection devices against stored game rules, algorithms, statistical models, or artificial intelligence techniques such as machine learning and/or deep learning. The error or inconsistency may then be communicated to the dealer via an output device 107 of the keypad 100, enabling the dealer to take appropriate corrective actions.

The reconciliation process may further notify surveillance staff that an error was detected and subsequently reconciled, thereby allowing surveillance personnel to review corresponding video footage or data captured by one or more detection devices. For instance, if the table monitoring system 50 detects an error such as a dealer paying a wager incorrectly at a particular position (e.g., “push paid in spot 3”), the dealer may correct the payout and then press the reconciliation button to acknowledge and resolve the alert. The system may record both the original error timestamp and the reconciliation timestamp, along with a reconciliation status flag, while continuing to monitor ongoing gameplay.

In some embodiments, certain detected events may not trigger an immediate dealer notification but may still be subject to reconciliation. For example, if the dealer initially collects a wager on a push but immediately recognizes and corrects the mistake without system intervention, the dealer may press the reconciliation button to confirm the correction. The event may remain recorded in the dealer’s log with associated timestamps and reconciliation data, thereby preserving an audit trail for accuracy, accountability, and regulatory compliance, while ensuring continuity of gameplay.

In further embodiments, reconciliation information or data may be provided to the keypad 100 not only by the dealer but also by a supervisor, casino staff member, or surveillance personnel. In some configurations, reconciliation events and data may additionally contribute to the calculation of a Weighted Average Dealer Score (WADS), thereby integrating reconciliation activity into overall dealer performance metrics.

Accordingly, the multifunctional keypad comprises a reconciliation input device configured to receive a reconciliation input from a dealer, and wherein the processor of the table monitoring system is further configured to execute or perform one or more steps that include: detecting, by a processor of a table monitoring system, an error or inconsistency during gameplay based on data received from one or more detection devices and/or input from a dealer, player, supervisor, or surveillance personnel; notifying the dealer of the detected error or inconsistency via an output device of a multifunctional keypad positioned at the gaming table; receiving, through a reconciliation input device of the keypad, a reconciliation input from the dealer; recording a timestamp corresponding to the detected error and a reconciliation timestamp corresponding to the reconciliation input; associating the reconciliation timestamp with the originally detected error and generating a reconciliation status flag; updating system records while continuing to monitor ongoing gameplay; and optionally communicating reconciliation information to surveillance personnel and optionally incorporating reconciliation events into calculation of a Weighted Average Dealer Score (WADS).

A display 104 or output device 107 may be configured to communicate with other staff members or departments in real time during game play. For example, if advantage play is detected at the table or if a disagreement occurs with or between one or more players, the dealer may press one or more input devices on the keypad 100 to alert casino management or security staff. Moreover, if there was an issue with a piece of equipment at the table, the dealer may request assistance from a technician or a supervisor via the one or more buttons or display.

In another example, one or more output devices 107 may inform a dealer of possible advantage play at the gaming table that is determined by the table monitoring system 50. This may put the dealer on notice and take appropriate action, while staying within the rules of the game.

In another example, one or more output devices 107 on the keypad 100 may be used to inform a dealer or host to provide a comp or benefit to a player at the table based on their performance. A dealer, supervisor, or host can spot the corresponding telltale output device 107 and approach the players accordingly. Such a discrete notification on the keypad 100 may go unnoticed by players and/or patrons to not cause a distract at the table or surrounding environment.

Accordingly, the one or more output devices 107 may be configured to provide an alert notification relating to detection of advantage play or a player dispute; a service request to a technician or supervisor in response to an equipment issue at the table; possible advantage play has been detected by the table monitoring system; and a discrete notification to a dealer, supervisor, or host to provide a complimentary benefit to a player. The notifications may be provided in a manner that is visible to staff but does not distract players or patrons at or near the table.

The keypad 100 may include one or more displays 104. A display may be a video or image device that a dealer or casino staff can view and interact with. A display may include one or more of the input devices 105 and/or the output devices 107. A display may be a touch screen (e.g., one or more of the input devices 105 may be an overlay or button on the couch screen). A display may be a non-touch screen. The display may be an LCD screen. The display or LCD screen may allow or enable the dealer to input player information, wager information, request assistance casino management or security staff, receive notifications, redeem and print TITO (Ticket In, Ticket Out) tickets, or any combination thereof.

The keypad and/or the display may include one or more buttons, overlays, keypads, etc. for the dealer to use. For example, the one or more buttons, overlays, or keypad may include numeric buttons numbered between 0 and 9, alphanumeric buttons A-Z, etc.

A display may provide certain relevant information to the dealer, surveillance, staff, etc. A display may include an e-ink display for showing or identifying the table number as a visual representation for surveillance to know the game number from one or more detection devices 28.

A display 104 may be configured to communicate information to the dealer of the game particulars, such as rules, buy-in amounts, payout amounts, etc. A display 104 may be configured to inform the dealer of their past or present performance metrics. A display 104 may be configured to interface or connect to another interface that allows for communication with other staff members or departments. For example, if advantage play is detected at the table, the dealer may press one or more buttons on the faceplate 100 or display 104 to alert casino management or security staff. Moreover, if there was an issue with a piece of equipment at the table, the dealer may request assistance from a technician or a supervisor via the one or more buttons or display. Moreover, if the dealer receives a tip, the dealer may hit a tip button on the display or on the faceplate and input the amount of money they are being tipped. It’s possible a chip recognition application verifies the amount tipped and the tip is stored in a virtual account for the collective dealer tip pool. Furthermore, hitting the button on the display or the faceplate for the tip may generate an audible response via a device, such as a transducer or speaker affixed to the gaming table, and/or a visual indicator of the tip on a signage system at the table.

The multifunctional keypad 100 may comprise one or more other input devices that may include one or more features disclosed herein. For example, an input device may include a tip device 109. If a table dealer receives a tip from one or more players, the dealer may push or activate a tip button 109 on the display 104 or on the keypad 100 and input the amount of money they are being tipped. It’s possible that a chip recognition application associated with the keypad or the table monitoring system 50 is configured to verify the amount tipped via one or more detection devices 26, 28 and the tip is stored in a virtual account or wallet. Furthermore, pushing the tip button 109 on the display or the keypad 100 generates an audible or tactical response via a visual, audible, and/or tactical output device 107 to be displayed on the keypad 100, table 10, or sign 24. For example, the visual, audible, and/or tactical device may comprise generating or displaying a light, picture, or text message; a sound, song, or bell, and/or a vibration of the table and/or chair. Such devices may include one or more lights, speakers, screens, and/or vibration devices like a motor.

After a dealer receives a tip from one or more players, the dealer may push one or more input devices or tip devices 109 on the keypad 100 or display indicating the tip and to log the tip. After verifying the tip with one or more detection devices 26, 28 of the table monitoring system 50, the tip may then be transferred a digital wallet associated with the casino, the dealer, or both. Receipt of a tip may cause a display or message to be displayed on the front and/or rear screen of a table sign 24 and/or turn on one or more lights, music, speakers, etc. to inform the dealer, supervisor, and/or other players at the table of the tip. The display on the sign or keypad may show a running tally or amount of tips that have been received and logged by the dealer so the dealer can easily keep track or be aware of it. This may advantageously allow the dealer to focus on game play versus trying to keep track of tips in their head or on a separate device. The display may also show a tip percentage rate, the number of hands that the dealer is tipped on, or a projected tip rate at the end of the day based on their game pace.

The keypad 100 or the tip device 109 may comprise a device for recycling tips. Such a device may be configured to receive a gaming chip that was gifted to a dealer by one or more players as a tip, register the chip as a tip, and then allow for that same chip to be placed back into the chip tray 18 for continued use in gaming. Advantageously, this may prevent the chip tray 18 from becoming depleted early or extend the lifespan of the chip tray 18 before it needs to be refilled. As one example, a camera associated with the keypad 100, chip tray, or the table monitoring system 50 may capture an image of the chip, identify it as a tip, enter the amount into a digital wallet, and then provide instructions to the dealer that the tip has been registered and that the chip can be placed back into the chip tray for further use or circulation. In other configurations, a dealer may toggle a tip button, enter the chip value, and then place the chip back into the chip tray for recirculation during game play. The value of the chip tip is stored in a digital wallet.

Accordingly, the multifunctional keypad comprises a tip input device and the keypad is configured for receiving, at a tip input device of a multifunctional keypad, a tip input from a dealer indicating receipt of a tip; verifying, by a chip recognition application associated with the keypad or table monitoring system, the tip amount using one or more detection devices; storing the verified tip amount in a digital wallet associated with at least one of the dealer or the casino; generating, via an output device, a visual, audible, or tactile response upon receipt of the tip input, the output device comprising at least one of a light, screen, speaker, or vibration device; displaying, on a table sign or keypad, at least one of: a running tally of tips, a tip percentage rate, a number of hands for which the dealer received tips, or a projected tip rate; and recycling a gaming chip provided as a tip by registering the chip as a tip, recording its value in the digital wallet, and returning the chip to a chip tray for continued circulation during gameplay.

According to these teachings, various dealer or casino performance data or metrics can be pushed or displayed to the keypad 100 or display for viewing by the dealer. The information can be provided to the keypad 100 or display from casino management, operations, surveillance, and/or from one or more table monitoring or analysis systems.

For example, one or more cameras, sensors, detectors, or the like (e.g.,. that are part of the casino monitoring system 50 that was previously incorporated by reference or separate from the monitoring system 50) or on the sign 24 or keypad 100 can be placed on or at the casino table, on one or more elements of the casino table (e.g., on a table sign, chip tray, card shoe, etc.), on the walls and/or ceiling of the casino, etc. to monitor or observe game play. Data relating to the game play, such as a video or image stream or detected via one or more sensors, can be provided to a computer, processor, or analyzing device, which is configured to analyze the data and generate performance data. The computer, processor, or analyzing device may be located at the casino table (e.g., an edge server or computing device), at the casino (e.g., on a casino network), or in a remote location or cloud (e.g., cloud based server). The computer, processor, or analyzing device may utilize one or more algorithms, look-up tables, machine learning, and/or deep learning to analyze the video and/or image feeds of the game play taking place at the table). The processed data can be output to the keypad and/or display for presentation to the casino dealer.

For example, the analyzing system can analyze input data and output information or metrics data relating to the number of hands that the dealer has dealt in a certain amount of time (e.g., in the last 5 minutes, last hour, since they came back from break, so far in their shift, etc.). This information can be pushed to and presented on the keypad 100 or display 104 for discrete viewing by the dealer in real time. This real time or dynamic information can be useful for the dealer to so they can adjust speed of the game, if they are dealing too slowly for example.

Performance or metric data or information may be provided or displayed on the keypad 100 as a specific number or value, or referenced against a goal or threshold that the dealer is evaluated against. For example, if the dealer is dealing at a slow pace and is below a target average or threshold, a message or indicator may be provided to the dealer to inform them that they need to speed up. If the dealer is dealing at normal or fast pace and is at or above a target average, a message or indicator may be provided to the dealer to inform them that they are at or exceeding expectations. Such information is preferably provided in a non-distracting way so that the dealer is not distracted by the updates, but can still be aware of their current status when they glance at the keypad, for example during a buy-in or in between hands.

In some configurations, the performance data or information can be communicated to the dealer using one or more output devices 107 having different lights or colors. For example, a green light may indicate the dealer is dealing at or above a threshold level, a yellow light may indicate the dealer is dealing at or slightly below a threshold level, and a red light may indicate that the dealer is dealing below a threshold level. Such indicators or output telltales may help the dealer understand they need to change the game pace if they are below or not meeting expectations, without having to read and interpret actual numbers or data.

The keypad 100 or display 104 may be configured to communicate information, guidance, or recommendations to the dealer from casino operations, management, and/or surveillance. For example, if a player takes longer than a predetermined threshold of time to make a decision during gameplay, a recommendation message may be sent to the dealer via the display 104 or output device 107 suggesting that the dealer encourage the player to speed up or provide assistance with the decision-making process. In another example, a recommendation may be generated by casino operations or an analysis device to alert the dealer to improve their time staging the table prior to dealing cards. Such a suggestion may include specifics, such as a comparison of the dealer’s current pace against an average or desired pace.

Accordingly, the method may comprise monitoring, by a table monitoring system, gameplay activity and player decision-making times; generating, by a processor of the monitoring system or casino operations, a recommendation when a player exceeds a predetermined decision-making threshold or when a dealer’s table staging time exceeds a desired pace; communicating the recommendation to the dealer via a keypad display or a staff-facing display of a hybrid signage system, the recommendation comprising at least one of: (i) a suggestion to prompt a player to act, (ii) guidance to assist a player in making a decision, or (iii) guidance to improve the dealer’s staging pace relative to average or desired timings.

In some embodiments, the recommendation or guidance may be presented via another medium, such as a rating system monitor or on a staff-facing side of a hybrid signage system that combines a table limit sign with a rating system monitor.

In some embodiments, when a new dealer arrives at a gaming table, the dealer may register as the incoming dealer by interacting with a staff-facing display, in a process referred to as “Tapping In.” At this stage, if a player is still active at the table—verified through a rating system lookup and/or facial recognition—the staff-facing display may provide specific recommendations or guidance to the new dealer based on past observations of that player’s behavior or activity at the table. Advantageously, this configuration ensures that incoming dealers are informed or apprised of how to handle or respond to particular players. Moreover, by communicating such operational suggestions via the staff-facing display, a rear-facing camera, or the keypad 100, the recommendations are conveyed privately to the dealer or staff without being visible to players or patrons at or near the gaming table.

In some configurations, the keypad 100 or display 104 may display side wager information. The casino operation might provide a revenue sharing metric with the dealer based on side wager utilization allowing the dealers to earn commissions tied to the utilization of side wagers. The keypad or display may store or provide theoretical (theo) amounts and current wager amounts and provide information about dealer commissions that are owed or earned based on a set rate for the casino operation for the side wagers being utilized. The theoretical amount and current wager amounts may also be uploaded or provided to a casino management system. This may advantageously help or motivate the dealer to promote side wagers to players. Such a methodology might be applied to maintaining or exceeding a desired level of dealer performance in which, when dealing at or above the desired pace, the theoretical amount for each wager is applied towards a commission for all or some of the wagers in play.

The keypad 100 or display may provide information to the dealer relating to the size of a progressive jackpot. The keypad or display may also include a device (button or the like) that allows for a dealer to lock in a progressive wager. The keypad or display may also provide additional functionality allowing the dealer to clear the current round of a progressive gam for new progressive wagers, display winning hands, trigger audible sounds for detected wins, used in conjunction with card recognition systems, or provide payout assistance based on the winning hand(s) in conjunction with a stored pay table. In other words, the keypad 100 may be in electronic communication with the progressive game and allow a dealer to update the jackpot or betting limits, announce a winner and/or clear the game for a next round to be played.

The keypad 100 or display may provide information to the dealer about how long the dealer has been working or clocked in, number of hands dealt, time until next break, time until end of shift, current time, or a combination thereof.

As discussed, the keypad 100 may be used as a tool or device for the casino to present data or information to the casino table dealer. The data or information presented to the dealer may include certain performance metrics or general communications that are sent and displayed in a generally discrete way that is not distracting to the dealer and/or nearby casino patrons. By presenting the information to the dealer, the dealer can be apprised of information in a discrete way, out of sign and view of one or more players at the table. Moreover, the dealer glance at the keypad 100 when they are free, which prevents the dealer from being distracted during game play.

During game play and/or between game play, the dealer may glance at the keypad, which is generally in their field of view when the dealer is in position at the gaming table (e.g., when the dealer is in the dealer area 14 of the table) and easily see information or data on the display or keypad. Due to the placement of the keypad on the table at the dealer area 14, the information or data is not readily viewable or distracting to casino patrons, who are generally on the opposite side of the table at the player area 12 of the table. In some instances, the use of an audible, visual (e.g., beacon or light) or haptic alert (e.g., vibration or pulse) may be utilized to alert the dealer to look at the keypad, especially if casino management, operations, and/or surveillance wishes to get the dealers attention.

The keypad 100 or display may be placed at other casino games, such as a roulette game. Information relating to the number of spins in the past hour or shift can be presented to the dealer so they are aware of their performance. Tips and other data can be presented to the dealer to keep track of their progress. Information or data relating to payout calculators can be presented to assist the dealer with calculating payouts to winning casino patrons. A countdown timer or “spin now” timer or information may be provided on the keypad or display to keep a dealer or casino table operator on track to meet performance metrics.

Other metrics, data, or performance information may be provided to the dealer via the keypad 100 or display. For example, the analysis device or casino operations or management may push information to display to the dealer about a dealer likeability factor by analyzing player body language and facial responses (e.g., slouching, smiling, angry, etc.), conversation factor (if the dealer is engaging in conversation with the players, etc.)

Metrics, data, or information may be provided to the display or keypad comparing the dealer’s performance metrics to other dealers. For example, information or data may be provided to the keypad comparing the number of hands the dealer has dealt compared to the number of hands dealers at other tables have dealt. This may provide an incentive or friendly competition amongst dealers during a day or shift. A dealer having high performance for a particular shift, day, week, month, etc. may be rewarded by the casino with an incentive such as additional pay or bonus, time off, clothing or apparel, a trip, etc.

Many benefits can be obtained by providing such real time information or metrics to a dealer. Notably, such information may incentivize a dealer to change their dealing or game play routine to increase numbers to meet or exceed certain metrics on the fly and in real time, as opposed to learning of their performance after their shift, or during an annual review or evaluation. Casino revenue may therefore increase immediately. Furthermore, real time feedback can be provided to the dealer if the dealer is performing at or exceeding expectations, which may even further motivate the dealer or employee to continue working or performing at that level. Such metrics may be stored for further analysis and training and may be revisited by casino management during evaluations (quarterly, semi-annually, annually) so there are no surprises for the dealers about their performance. Moreover, by providing the ability to provide recommendations to the dealer to increase game play speed and/or to incentivize dealers to promote certain additional bets such as side wagers, casino operations may see an immediate increase in revenue, as opposed to reminding staff and dealers to make such promotions before or after a shift change. Lastly, by providing this real time information and feedback to a dealer, the dealer can be kept updated about their performance, without distracting them with information on the back of a table sign for example, or having a pit boss or other supervisor interrupt them during game play to provide such feedback.

The keypad 100 or the display may include a swiping function that allows a dealer or casino staff to swipe or toggle between two or more screens or displays. For example, one screen or display may provide ongoing performance metrics to the dealer, another screen may provide player input or information, another may provide amount of tips, etc. A dealer may swipe or toggle between these and other screens by swiping or using one or more buttons or inputs.

The keypad 100 may include one or more card readers or scanners 106. The one or more card readers 106 may be utilized for swiping player club or loyalty cards, dealer identification cards, and any other cards with a magnetic stripe or chip to retrieve information from encoded media, such as that on a magnetic stripe card, smart card, bar code card, or other suitable devices. For example, a dealer may swipe a player loyalty card to generate player recognition data, such as an account or identification number that can be associated with a player. For example, a dealer may swipe their identification card at when they arrive at the table 10 to deal. This may be used for assigning statistics of the table to the dealer or for verifying their timeliness arriving from their break. The dealer may also check players in at the gaming table via the keypad, display, or card reader. A dealer may use the barcode reader or MSR to scan driver’s license or loyalty card to verify the cards are valid and/or that the player is eligible to play (e.g., the player is of age, not banned from playing at the casino, etc.)

In another example, a dealer or supervisor may use the code on a player’s driver’s license to create a player account for the player at the table. As discussed further below, this step may take place using the keypad 100 and/or sign 24 and more specially the rear screen that faces the dealer area. In another example, if a dealer, supervisor, or staff believes a player is potentially underage, they may scan the player’s (or potential player’s) driver’s license to verify the age of the person in question to validate it. The system may store the driver’s license information and assign the information to a facial recognition profile for the person. If the person arrives at a different gaming table, the faceplate or rear screen on the signage may show a visual indicator that the person has previously been ID’d and they are of a legal gambling age. Or alternatively, if the person arrives at a different gaming table, the faceplate or rear screen on the signage may show a visual indicator that the person has previously been ID’d and they are not of legal gambling age. In an embodiment, if the one or more card readers or scanners 106 is not operational or broken and/or if a particular gaming jurisdiction does not allow for scanning of identification cards or driver license cards, then the dealer or supervisor may manually input the player’s identification card or loyalty card number and/or the player’s birthdate via the one or more input devices on the keypad 100. The birthdate and/or the number may be stored in the memory and used for further analysis and/or processing as disclosed herein.

The keypad 100 may include one or more barcode readers 108. A barcode reader 108 may be used for scanning barcodes, QR codes, coupons, promotions, or reading any other type of information commonly read by barcode readers. The barcode reader 108 may be used to scan one or more TITO tickets, coupons, vouchers, or other items relevant to the table. A dealer may use the barcode reader or MSR to scan driver’s license to verify they are valid.

The keypad 100 may include one or more communication devices 110. The one or more communication devices 110 may be wired and/or wireless communication devices that are configured to allow one or more peripheral devices to connect to the table and/or to the keypad 100 to detect the proximity of items using localization. A peripheral device may be a table screen, sign, computer, processor, or other device used by other casino employees or staff such as surveillance or management. Such devices may be tags affixed to a dealer tray or two-way communication with mobile phones. The one or more communication devices may be a Wifi communication device, an ultra-wide band communication device, a Bluetooth communication device, the like, or a combination thereof. A communication device may be a wired device such as a cable, wire, port, plug, etc.

The keypad 100 may include one or more finger print readers 112. A fingerprint reader 112 may be configured to determine an identity of a particular person at the table, such as a dealer or manager. This may be utilized instead of a card for the dealer to check-in at the table or for the dealer or manager to approve a transaction. It may also be used to perform transactions where added levels of security are needed.

The keypad 100 may include one or more controllers 112. The controller may be part of the electronics device 111. While each of these components may be connected to a processing device within or in the proximity of the keypad 100, the components may connect to a controller 112. The controller 112 may allow the components to connect to one board. The controller would then allow for a connection to a processing device for managing the interface. It is possible the keypad 100 is the processing device. In addition, a connection to a PC may allow for a single cable transmission of data and power. A controller may be or comprise a microcontroller, a printed circuit board (PCB), a processor, computer, machine learning model, deep learning mode, memory, software, algorithm, look-up table, or any combination thereof.

The keypad 100 may include one or more input devices in the form of a ticket button 114 for activating a ticket printer to print tickets, vouchers, receipt, etc. For example, when a player wishes to cash out from the table, the ticket printer may generate a printed ticket. This ticket shows the amount of money the player has, which can be redeemed for cash or used as currency at another table or slot machine. These tickets are generally referred to as TITO tickets or slot tickets. They are usually printed using a thermal printer connected to a device that has a communication link to the casino or table management system 50 or any other system capable of printing and/or redeeming tickets that can be converted to currency (virtual or physical).

The keypad 100 or barcode reader or sign, or other peripheral device may be configured to scan a TITO ticket so that a player can fund game play at the table 10. Upon being presented with a TITO ticket or other coupon or voucher, a dealer would push or tap a TITO button on the faceplate 100 and scan the ticket. The system may show the amount on the player facing front screen of the sign 24 for the player to witness. The dealer would then prepare the chips from the chip trey that equal to dollar amount that the player redeemed. The dealer may then tap a complete button. The front screen of the sign may fade the transaction image out or show complete and go away. Furthermore, the secondary or back screen might maintain information related to this transaction for the supervisor to input into the system. It is possible this information might be written directly into a player rating system.

In the event that the TITO ticket comprises a currency amount that a dealer cannot redeem or offer a gaming chip for, for example, less than $1.00, then there remining balance can be donated to either the dealer or a charity associated with the casino, or a charity that a player can select. For example, if a player presents a TITO ticket in the amount of $102.47, then the controller 112, the one or more ticket printers, and/or the keypad 100 may provide for the dealer to offer the player $100 in game play currency and the remainer of the amount $2.47 will be offered as a tip to the dealer and/or donated to a charity. If the player wishes to keep the entire balance $102.47, then the player may be instructed to approach a kiosk or counter at the casino to redeem the full amount $102.47 or the left over amount $2.47. The amount to be redeemed, donated, and/or left as a tip may be displayed on the sign 100 (front and/or rear screen), the faceplate, the ticket printer, or any combination thereof.

In another configuration, if the value of the TITO is an amount that the dealer or game table cannot redeem for its full amount, then the one or more controllers 112, the ticket printer 114, and/or the dealer may receive an error and not allow the payout to continue. In such a situation, the player may be instructed to approach a kiosk or counter at the casino to redeem the full amount.

In another configuration, if a player presents a TITO ticket in the amount of $102.47, then the controller, the one or more ticket printers, and/or the faceplate only checks the amount of the left of the decimal point, and the rest is automatically donated or provided to the dealer as a tip. In this regard, the controller, the one or more ticket printers, and/or the faceplate does not engage in any decision making on what to do with the money that is to the right of the decimal point. In the above example, the player would be eligible to redeem $102 and the rest of the amount $0.47 would automatically be donated to charity or given as a tip to the dealer or casino.

In another configuration, if the value of the TITO is an amount that the dealer or game table cannot redeem for its full amount, then the one or more controllers, the ticket printer, and/or the dealer may receive an error and not allow the payout to continue. In such a situation, the player may be instructed to approach a kiosk or counter at the casino to redeem the full amount.

The keypad and/or table may be able to receive a mixed transaction amount (i.e., tickets and currency from a player). In other configurations, the keypad can only accept a single transaction amount from the player (i.e., tickets or currency but not both).

When a player wishes to cash out or leave the table and “walk” with a TITO ticket, a dealer may prepare the chips in front of the chip tray, push the walk button or appropriate input device on the faceplate 100 and type in the amount. Upon hitting submit, if the amount is greater than a predetermined limit, the dealer may be required to provide a verification of their identity. This could be a fingerprint, a barcode scan, badge scan via MSR, and/or a PIN or any other unique identification method on the key pad, peripheral, and/or sign. If the amount is above a secondary amount, it might be required that the supervisor require a verification. This would require the supervisor to use any of the plethora of peripherals of the secondary screen to verify their identity to approve the transaction. Once the transaction is approved, if necessary, a TITO ticket would be printed at the table or a nearby location.

Mobile transactions may function in a similar manner. If a user elects to transfer funds to a table, if they are using UWB/BLE, they will detect the table they are to transfer. The UWB/Device would connect to their mobile phone to create the transaction bridge. Once the controller device recognizes the transaction, the information for the transaction might show up on the faceplate and the player facing or front screen on the table sign 24. It might be possible the Player facing screen shows a code the player needs to type in to verify their location at the table. The dealer would then stage in the amount the player is buying in for. They would then press submit and the transaction would process. It is possible the Player facing or front screen of the sign 24 shows a successful message. The dealer might select which position the player is playing at. Further information might be gathered from the transaction, such as amount, player card swipe data, etc., for staging on the second screen for input into a legacy rating system that requires physical card swipes and the input of buy-in, average bet, etc. It is possible this information is written directly into the rating system.

The keypad 100 may include one or more RFID/NFC readers 116. An RFID/NFC reader 116 may also be added for cards or phones that are capable. An RFID/NFC reader 116 allows for players to transfer data, such as loyalty card information or banking information, to the table. They may also use this method for tapping their phone or allowing a dealer to tap their phone, to transfer money from a mobile wallet or financial institution. For instance, the user may use a mobile payment, such as APPLEPAY to transfer funds from their financial institution to the gaming table via the RFID/NFC reader. The user may also store, in a mobile wallet, or in a mobile app, a virtual players card that they may tap to the RFID/NFC reader. Such a transfer may provide an overlay on the rear screen of the sign 24 with the emulated card swipe date, as well as other information related to the player such as buy-in, average bet, etc. for inputting into the rating system.

In some configurations, a player or potential player, or user may desire or elect to use a mobile application on their mobile device to create a virtual wallet card for use in transferring funds to and from the casino. The user can select the predetermined amount of funds they would like to withdrawal from their account. For instance, in the casino mobile application, the user may select $200 as their preferred withdrawal amount. This would create a virtual card, stored in their wallet, for a $200 withdrawal. The user would then simply access their wallet on a mobile deice to find this card. This method advantageously expedites processes as the user doesn’t have to enter a mobile app, login, and navigate to a transaction page to perform arrive at this end result. The transfer of the funds will provide card swipe data, and/or loyalty account information.

The keypad 100 may include one or more detection devices or cameras 120. The one or more cameras 120 may be configured to monitor table game play, monitor one or more players, monitor the dealer, or any combination thereof. For example, the one or more cameras 120 may be configured to obtain one or more still images or video feeds and communicate the still images and/or video feed to a processor at the keypad 100 and/or the table monitoring system 50 for analysis. The one or more cameras may be arranged on the top and/or outer edges or sides of the keypad that face the player area 12. The analysis may include facial recognition to identify a player at a table, appendage detection to identify game play at the table (i.e., gestures, who placed a bet, etc.), chip recognition to identify chip placement and value, card value to identify winning or losing hands or any anomalies, or any combination thereof. The one or more cameras and/or the keypad 100 may be one or more input feed or elements into the system 50 illustrated and described in commonly owned US Patent Application No. 18/884,502 filed on September 13, 2024, which claims priority to US 63/582,281 filed on September 13, 2023, the entireties of which are hereby incorporated by reference herein for all purposes.

In some configurations, the one or more cameras on the sign 24, faceplate 100, and/or the chip tray discussed below, may be used for detecting and/or determining if a player’s hand or fingers are in a region of the one or more betting regions 16, on the table 10 ready to make a play (e.g., add chips, remove chips, pick-up cards, put down cards, roll dice, etc.). This detection by one or more of the respective cameras may be used to correlate the one or more hands or fingers to a particular player at the table 10. The fingers or hands or the correlation to the one or more players at the table can then be linked to a player profile (that was set up or inputted into the computer system when the player arrived at the table 10 or shortly thereafter). The system can then monitor the game play by analyzing the hands and/or gestures at the table and apply them to the player profile and player rating system.

In some configurations, the correlation or detection of the players hands, fingers and/or movements/gestures thereof can result in the name of player being displayed on the faceplate screen, the sign screen (rear and/or front), or both. This may result in a more personalized gaming experience, by allowing the dealer and/or other players to know who they are playing next to, at least on a first name or nickname basis. The sign or the screen of the sign that faces the players can be programed to include a welcome screen with the player’s name and/or basic information when the player arrives at the table 10.

The keypad 100 and/or the one or more cameras 120, and/or the one or more elements of the keypad 100 such as the card reader, can be used for enrolling players into a loyalty or players club. For example, if a player is at the table and is not enrolled in a players or loyalty club, then the player may present their identification card or credentials to the dealer, who can use the one or more cameras 120, card reader, at the keypad to enroll the player into the loyalty club.

The keypad 100 may include one or more RFID readers 122. An RFID reader 122 may be configured to validate one or more gaming tokens that have RFID information. This may enable the dealer to quickly and accurately validate gaming chips or tokens as authentic. An RFID reader 122 may be used to initiate and complete transactions between the casino and a player. For example, a player may stage a monetary transaction on their mobile phone or device and complete the transaction by communicating the funds to the casino or table via the RFID reader 122 and/or the ultra-wide band. Other forms of communicating in addition to RFID may be or may include ultra-wide band, Bluetooth, etc., or any combination thereof.

In the event the keypad includes the ultra-wide band capabilities, when a player enters a region of interest at the table, then the ultra-wide band at the keypad may identify the player and/or the player’s device. A transfer of currency may then take place from the player’s phone or mobile wallet to the keypad and/or controller associated with the keypad and then to an institutional financial center. The dealer may then enter the amount into the face plate or confirm the amount on the face plate and then provide the gaming chips or currency to the player.

For example, in some configurations, a player or potential player, or user may desire or elect to use a mobile application on their mobile device to create a virtual wallet card for use in transferring funds to and from the casino. The user can select the predetermined amount of funds they would like to withdrawal from their account. For instance, in the casino mobile application, the user may select $200 as their preferred withdrawal amount. This would create a virtual card, stored in their wallet, for a $200 withdrawal. The user would then simply access their wallet on a mobile deice to find this card. This method advantageously expedites processes as the user doesn’t have to enter a mobile app, login, and navigate to a transaction page to perform arrive at this end result. The transfer of the funds will provide card swipe data, and/or loyalty account information.

The keypad 100 may include one or more currency note or ticket validators 124. A validator 124 may be used for validating currency and/or documents that are inserted into the one or more slots 102. The validator 124 may be a bill or ticket validator that validates authenticity of currency, gaming chips, TITO tickets, coupons, etc., before during or after it is inserted into the keypad slot 102. In the event the validator 124 determines that the currency and/or documents is not legitimate or a question or authenticity is raised, an alert may be provided at the keypad, the table sign (i.e., at the rear screen), or both. This alert may prompt the dealer and/or the supervisor to be required to take further action to resolve the issue. The validator may be located at least partially within the slot into which the currency and/or paper work is pushed. The validator 124 may be external of the slot and may be connected to a door. In some configurations, the validator 124 must first validate and accept the currency, ticket, gaming chip, paperwork, etc. as authentic before the door is opened to allow the item(s) to be inserted into the slot and then the drop box. In the event the validator does not validate the item, the door will not open and the item will not be allowed into the drop box.

In other configurations, the validator may be located under the table and/or adjacent to the drop box. The validator may scan the item and if the item is not validated, then the item will be placed into a separate region of the drop box, a different drop box, or returned to the dealer with a message that the item was not validated.

What follows are exemplary applications of the keypad 100 according to these teachings.

In some configurations, the keypad 100 allows for a dealer to input Player Loyalty information into the system via a physical medium, such as a card swipe or barcode read. The keypad 100 may even utilize facial recognition to determine the player at the table rather than requiring a loyalty card. Another method may allow for a virtual transfer of a player card and/or a transfer of funds via a mobile wallet, a market account created for the player, a front money account created for the player, or financial institution using a mobile phone and Bluetooth (Bluetooth low energy or Bluetooth). This might be combined with UWB to determine the proximity of the player to the table. They may also allow for transfer via mobile phone using NFC/RFID. When such an input takes place, a welcome message might be displayed on the front or player facing side of the sign 24. Furthermore, the system may use facial recognition to determine that the player is no longer at the table. The faceplate and/or the staff facing side of the sign 24, may indicate this or requesting to stop a player rating. The system may also end the rating automatically by stopping it in the CMS. A casino Management System (CMS) software or system may be a program or software configured to assist in the on-going management, monitoring, and operations of casino or gaming organizations. For example, a CMS may include features for accounting, bonusing, player performance tracking, jackpot solutions, reporting, security, surveillance, table management, and cage, slot, and electronic gaming machine (EGM) management.

In some configurations, the keypad 100 may be configured to immediately start a rating or stage the information for a rating. Rating systems usually include older software systems. Many rating systems only allow for card swipe data to be entered into the system. Therefore the keypad 100 according to these teachings may take the data acquired via any of the above methods and stage this information in the keypad electronic device or communicate the data to the casino management system as a virtual card swipe. This pending card swipe might be displayed as a name and/or a player position on the player rating software screen. The taping of a button may trigger an emulated card swipe for the system to digest.

An emulated card swipe can also be utilized when a player rating is received by the keypad 100 from another source or way, for example, from a BLUETOOTH communication or ultrawide band data communication. For example, a player may provide information to the keypad 100 for example via their mobile device which can be communicated to the keypad 100 or electronic device of the keypad via a BLUETOOTH or ultrawide band connection. This data may be stored locally in the keypad 100 and/or transmitted into the casino monitoring system to begin the player rating system or process. Such data transfer or initiation of data transfer may be equivalent to a dealer or supervisor swapping a player loyalty card or identification card.

The keypad 100 according to these teachings may be a peripheral device that communicates information or inputs to the monitoring system 50, which includes one or more of the processors for executing one or more of the method steps disclosed herein. In other words, the keypad 100 may be a peripheral device that is used to collect information and inputs and then communicate the information or inputs to the processor for executing the method steps disclosed herein. The processed information or results may then be communicated back to the keypad 100 for presenting information or data to the dealer via the one or more output devices.

In another embodiment, the keypad 100 may include one or more processors or processing devices. Some or all of the method steps disclosed herein may be performed on the processor of the keypad 100. If only some of the processing is performed on the keypad 100, then the other method steps or calculations may be performed on one or more processors associated with the table monitoring system 50.

In some configurations, a casino may require a floor supervisor to input player rating information to start a rating. Player Rating input information generally consists of loyalty card data, buy-in, and average bet. Once the player details are known, or the dealer chooses “unrated player”, via the touchscreen, the dealer would select the person, define the seat, the buy-in amount, and any wager information they witness. This information, as well as the timestamp, may be written directly into the Player Rating System, commonly referred to as the CMS. Another option may be that the hardware running the rating system will show an overlay on top of the rating system with the player information and the mentioned details. The pit staff overseeing the game would then input the overlay information into the CMS. Another implementation may be a combination of the listed methods but also storing information applicable to the players face as an identifier in the absence of identification. Another method stores the information in a separate player value system that maintains information on player gaming history and behavior.

In some configurations, the keypad 100 may allow a dealer to notate changes or observations in in betting behavior or other game pay behavior, thus impacting average bet, into the system for direct input into the CMS or for the staff to modify via an overlay notification on the rating system device. The betting changes or observations by the dealer may be input into an ancillary system to the CMS that is configured to store player play behavior and observations based on a player profile or facial recognition with or without specifically tying the information or observation to the payer via their name, date of birth, etc. Advantageously, this may allow the casino to build custom player profiles for patrons based on custom observations by dealers, which may not be possible with current CMS.

In some configurations, when a player leaves the table, the dealer may use the keypad 100 to close out a rating and input the amount the player left the table with. Furthermore their input might display an overlay recommendation to close a rating and along with the amount the player left the table with.

In some configurations, the keypad 100 may allow for scanning physical coupons and accepting coupons transferred digitally via Bluetooth or NFC/RFID. Match Play is a common promotion method casinos use to bring players back to the gaming table. Some casinos mail these coupons to players while some print them from emails. Some allow for mobile apps to present the barcode allowing them to be scanned. However, many gaming commissions require that a physical record of a coupon is retained for audit purposes. The coupon provides a paper trail of the coupon as well as an indicator for surveillance that the match play is being played. The dealer generally places the coupon next to their matching value wager. The system allows for redeeming a coupon via a digital method and marking it as redeemed in the system. The system also allows for doing the above while also printing a physical coupon for inputting into the drop box after use and informing surveillance that the coupon is in use.

In some configurations, the display 104 may allow the dealer to communicate with various entities in the casino as well as trigger alerts. For instance, if an anomaly is detected at the table via surveillance, the dealer may receive a message to pay a particular player back for a wager taken when it should’ve been paid. Conversely the dealer may trigger an alert to surveillance if a player is overly intoxicated or they appear to be counting cards.

In some configurations, a notification may be presented on the display 104, possibly accompanied by an audible queue on the alerting device 118 to alert the dealer of the change in the minimum wagering amount on the table.

In some configurations, when a player presents a ticket, the dealer selects TITO Ticket Redemption which activates the barcode reader, redeems ticket for chips and a ticket for any cents is issued as cents cannot be given at the table. Chips amount being delivered to players may be vetted by a chip value recognition system.

In some configurations, when a player wins and looks to cash out, the dealer may collect chips from player and stages them. Chips amount being delivered to player may be vetted by a chip value recognition system. Dealer hits a cash-out button on the keypad 100, and the system calculates the chip total, and/or the dealer manually types in the amount.

In some configurations, for added protection, or if a predetermined amount is exceeded, the use of the fingerprint reader, or the swipe of a dealer card, may be needed to process the issuing of a TITO ticket. Furthermore, utilizing the existing fingerprint reader, or an additional verification method, such as a fingerprint reader, barcode reader, MSR, a supervisor would be able to use their authentication method to approve a transaction. A linked approval process might also allow the dealer to approve a transaction using one of the methods listed, while surveillance approves the transaction from a remote destination. Furthermore, the use of a camera might be required in combination for the transaction amount and the incoming chip values to match. For example, a player cashing out $100 in chips might allow for the dealer to press the Cash Out button and input $100 and press print. They would then be asked for their fingerprint. Once received, the ticket is printed. Another example might consist of a player cashing out for $500. This amount exceeds the single authorization threshold. Therefore the dealer would tap Cash Out, input $500, and provide their fingerprint. The supervisor would be alerted to come to the table. The supervisor would then provide a secondary approval of the transaction utilizing any of the methods listed.

The keypad 100 may comprise one or more ultrawide band devices and/or may be configured to communicate with one or more ultra-wide band devices. An ultra-wide band device maybe a device referred to as an anchor or tag, and which are configured to communicate electronically with one another. Such anchors and tags are closed in commonly owned US Patent Applications 18/621,416 filed on March 29, 2024 and 18/884,502 filed on September 13, 2024, the entireties of which are hereby incorporated by reference herein. For example, the keypad 100 may comprise one or more ultra-wide band anchors that are configured to determine or identify one or more tags that may be provided in one or more gaming chips to identify a currency and/or location of one or more gaming champs on the gaming table. This information may be transmitted to the table monitoring system 50 for analysis and processing.

FIG. 5 is an example of a gaming table 10, keypad 100, and a drop or utility box 32 located below the gaming table 10. The keypad 100 may be placed onto or over the gaming surface or top 5 of the gaming table 10 such that the one or more keypad slots 102 (e.g., one or more of the slots disclosed herein including slots 102, 113, etc. described previously) are arranged over or at least partially aligned with one or more drop box slots 22 defined in the gaming surface 5 or table 10. This arrangement advantageously allows for items to be passed through the one or more slots 22 in the table. For example, items can be inserted or deposited or dropped downwardly into the drop or utility box 32 through the one or more keypad slots 102, 113 for later handling or disposal. For example, items such as coupons, cashless tickets, or vouchers (e.g., TITO tickets) can be presented to a casino dealer or personnel upwardly through one or more of the slots 102, 113, etc. that are stored or are printed via a printer or inventory located at or below the gaming table 10.

In the example schematically illustrated in FIG. 5, the keypad 100 comprises two keypad slots 102, 113. The utility box or drop box 32 comprises two regions or chambers 126, 128. The first region or chamber 126 may be isolated from the second region or chamber 128 via one or more walls or dividers 131.

The first region or chamber 126 may be configured to receive and at least temporarily store currency and/or ticket vouchers. The second region or chamber 128 may comprise a ticket printer and/or one or more ticket rolls or ticket stacks 132 that may be fed or delivered to the ticket printer 130. The tickets may be connected together in the rolls or stacks or may be separated from one another before the tickets are printed by the ticket printer.

Each slot 102, 113 may be aligned with or in communication with a respective one of the chambers 126, 128. There may be more than two keypad slots and/or drop box chambers.

In one operating example, a player may present currency to a casino dealer for a buy in to the game. The currency may be a cash, gaming chips, and/or a cashless ticket or voucher, such as a TITO ticket. A casino dealer may scan the cashless ticket or voucher with a scanner or currency detector that is located at the gaming table and/or part of the keypad 100. For example, the keypad 100 may include a ticket validator (e.g., element 124 described above in FIG. 3). The dealer may insert the redeemed ticket into one of the keypad slots (for example, slot 102) and the currency detector or validator may scan and capture data from a code or barcode on the cashless ticket. A memory device in the keypad 100 or processor at the table or in a remote location may store or respond to one or a plurality of instructions that, when executed by the processor, cause the processor to respond to a capture from the cashless ticket by associating the capture with a currency value that can be credited or applied to the player or their account at the gaming table. The dealer may give or redeem a value of the cashless ticket to the player via gaming chips from the chip tray or a digital payout to a player e-wallet at the gaming table. The redeemed ticket may fall into one of the chambers (for example chamber 126) in the drop box 32 that is in communication with the slot 102, and be stored in the camber for later collection or handling.

The keypad 100 and/or the utility or drop box 32 may include a device 127 for destroying and/or for identifying the cashless ticket as having been redeemed. For example, the device 127 may be a printer or stamp that applies one or more distinguishing features or marks to the cashless ticket or code. For example, the device 127 may be a knife or shredder that is configured to perforate the ticket, cut one or more corners of the ticket, destroy the code or barcode to render is unreadable, shred the ticket, etc. This application of a mark or destroying the ticket may provide casino staff or surveillance an easy way of identifying the ticket has redeemed and/or disposing of the ticket, without risk or question whether the ticket has been in fact redeemed, has any value, etc. Accordingly, tickets that have been redeemed and in the chamber 126 may be destroyed or have the mark on them and pose less of a security risk or threat.

The keypad 100 and/or drop box 32 may include one or more counting devices 129 for counting or estimating the number of cashless vouchers, tickets, or coupons that have been deposited or inserted into the drop box or are in the one or more chambers. For example, the device 129 may count or scan each ticket as it is inserted into the drop box 32 and store the number of tickets in a memory or processor associated with the keypad 100 or table processor. In another example, the device 129 may be a scale that weighs the contents of the drop box 32 and a processor associated with the keypad, drop box, or table system 50 can determine or estimate when the box 22 or chamber 126 is getting full. In another example, the device 129 may be or include a proximity sensor that, when a substantial number of tickets has been accumulated in the chamber 126, will provide a signal or alert to the dealer (e.g., via an output device 107 or other telltale on the keypad 100 or other alerting device at the cage, casino pit boss, or surveillance) that it is time to empty the drop box chamber 126.

The drop box 32 may have a second chamber 128. The second chamber 128 may be located above the first chamber, next to the first chamber, or below the first chamber. The second chamber 128 may comprise one or more ticket printers 130 that is/are configured to print cashless tickets or vouchers directly at the gaming table 10. For example, when a player wishes to “cash out” their cash balance at the table, the casino dealer can utilize the keypad 100 to “cash out” a player, for example, pushing one or more input devices or buttons on the keypad 100. The dealer can collect any remaining gaming chips from the player and input the value into the keypad 100 via the one or more input devices. The game monitoring system 50 via the one or more detection devices 26, 28 (FIG. 1) may count or confirm the number of gaming chips that the player is redeeming to confirm the amount. The ticket printer 130 may then print or apply the currency value onto a blank ticket that is in a blank ticket roll or a blank ticket stack 132 that may be located in the chamber 128. The printed ticket can then be presented to the casino dealer upwardly through one of the slots 113 defined in the keypad 100 through the slot 22 in the table to issue to the redeeming player or at a ticket printer in the vicinity or area delivered by a supervisor.

The keypad 100 comprises a first slot 102 through which currency and/or paperwork is configured to be passed through the multifunctional keypad 100 and into the first chamber 126 of the utility box 32.

The keypad 100 may comprise a second slot 113, through which tickets printed by the ticket printer 139 in the second chamber 128 are configured to be passed through for presentation to a dealer.

In another configuration, illustrated and described in the example in FIG. 10, tickets printed by the ticket printer 132 in the second chamber 128 are configured to be presented to a dealer of the casino table in a region adjacent to the gaming table 10 (e.g., not through the keypad 100 or through any slot defined in the keypad 100, gaming table 10, etc.).

To prevent currency, vouchers, chips, etc. from being inserting into the wrong slot, the first slot 102 may be larger in size than the second slot 113. In this regard, the smaller slot 113 would make it difficult for a dealer to unintentionally deposit or insert cash, vouchers, chips, etc. into the second slot 113. In this regard, the size of the second slot 113 may be only slightly larger than a typical size of a voucher or cashless ticket. The size of the first slot 102 may allow for a plunger or paddle to be inserted into the slot 102 to push any cash, tickets, chips, etc. into the first chamber 126. A wall or divider 115 may separate the two slots 102, 113. The wall or divider 115 may be curved or at an angle to restrict or prevent items from being inserted downwardly into the slot 113, but still allow for items to be passed upwardly through the slot. In some configurations, the wall or divider 115 may include a door or hinged door that is closed in most instances but opens when a ticket or coupon is printed and presented upwardly through the slot. The wall 115 or door may include a perforated or serrated edge or side that allows for a dealer or casino staff to cut or rip or separate the ticket from another ticket after it is printed and presented upwardly through the keypad 100.

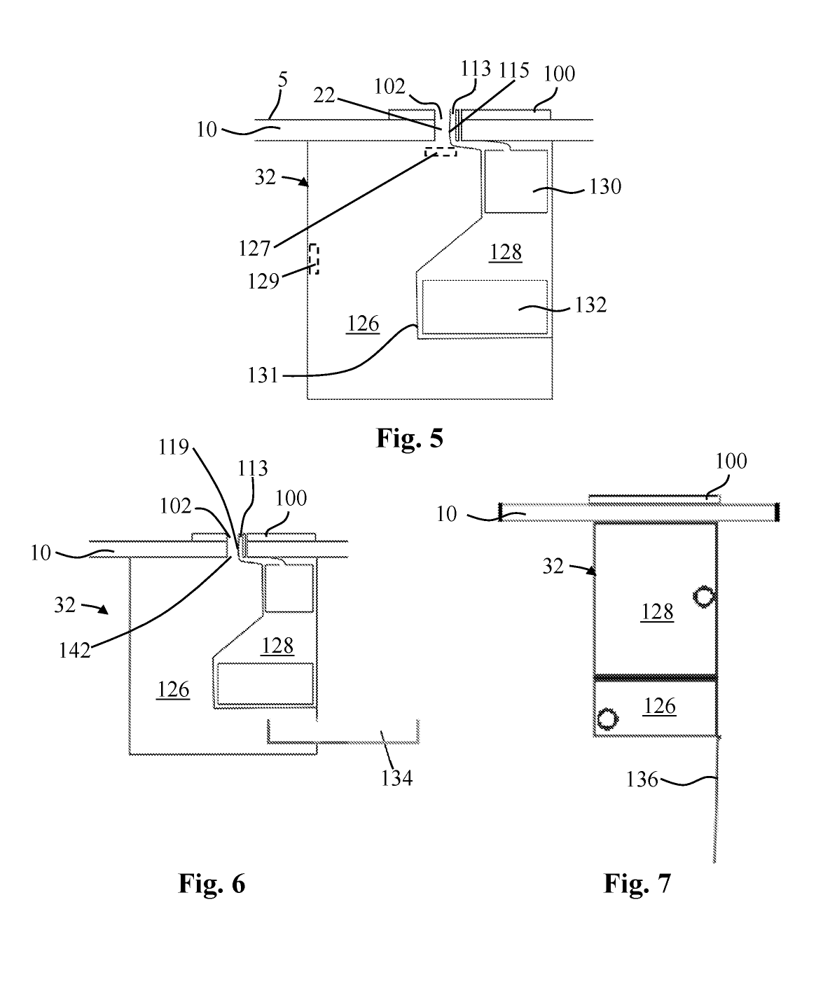

Referring now to FIG. 6, the utility or drop box 32 has a removable box or drawer or tray 134. The drawer or tray 134 is configured to slide out of the utility box 32 in a generally horizontal direction relative to the upper gaming surface to remove contents from the first chamber. For example, when the chamber 126 is full of redeemed tickets, the utility or drop box 32 can be opened and the tickets can be removed from the drawer 134. The drawer 134 may be locked and accessible only by casino surveillance and staff. The drawer 134 may be on sliders that the permit the drawer to open horizontally relative to the table or gaming surface. The contents of the drawer 134 can be removed and then taken for further processing. The empty drawer can then be put back into the drop box 32 for further game play.

In FIG. 7, the utility or drop box 32 is shown where a bottom door or wall 136 can be opened to remove contents from the first chamber 126. For example, stored or redeemed tickets, coupons, vouchers, etc. can drop or fall into a container or bucket that can be placed below the box 32 and taken for further processing. The bottom or wall 136 can then be closed for further game play. In another configuration, the bottom wall 136 may be a door 136 that can be opened or closed to obtain access to the drop box 32. In another example, like those illustrated and described in FIGS. 7-9, the door 136 can be provided on another part of the drop box 32, to make accessing contents of the drop box 32 more convenient for casino staff and to prevent items from falling out of the bottom of the drop box 32.

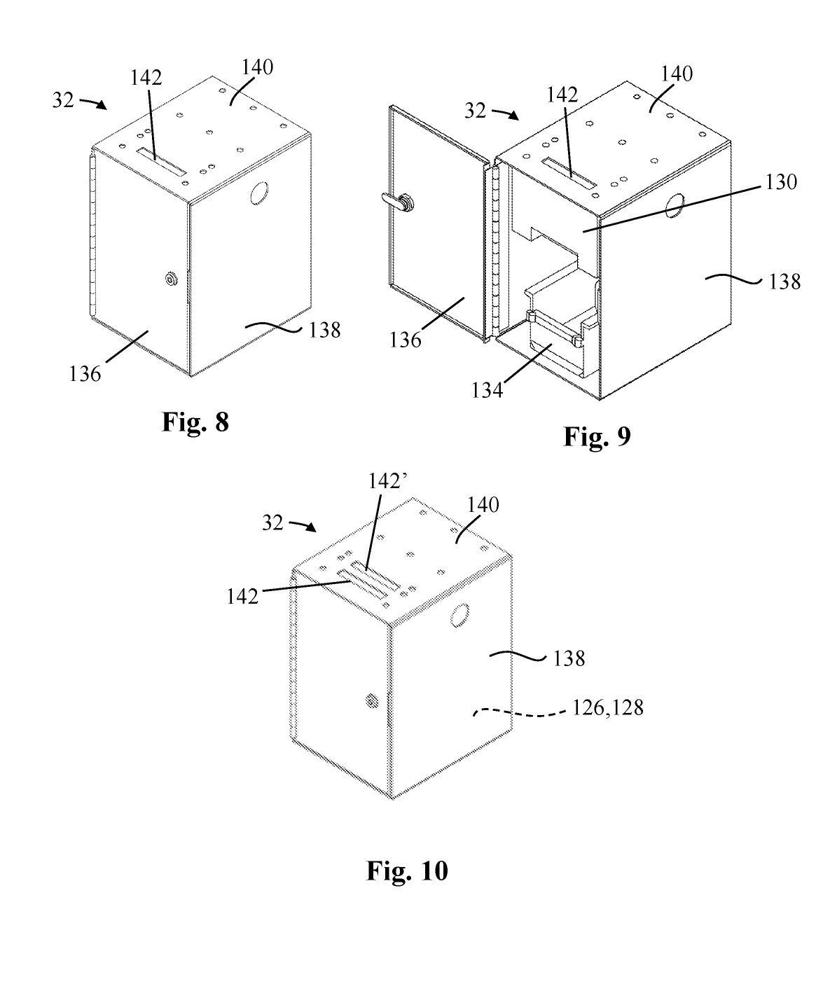

FIGS. 8-10 illustrate a utility box or drop box 32. The drop box 32 comprises a container or box-like structure 138. The drop box 32 has a top or upper surface 140 with one or more openings or slots 142. These slots 142 may be referred to as a first utility box slot 142 and a second utility box slot 142’. The slots 142 may be arranged substantially parallel to one another. The first utility box slot 142 is configured to be aligned with and in communication with the first slot 102 of the multifunctional keypad 100 and the first chamber 126 of the utility box. The second utility box slot 142’ is aligned with and in communication with the second slot 113 of the multifunctional keypad 100 and the second chamber 128 of the utility box 32.

The drop box 32 is configured to be mounted or installed at or under a casino gaming table so that the one or more openings or slots 142 are at least partially aligned with one or more openings or slots (e.g., 102, 113, etc.) defined in the gaming table and/or keypad. Depending on the configuration of the drop box 32, the gaming table 10, and/or the keypad 100, items can be inserted into the drop box 32 via the one or more openings or slots 142 and/or obtained from within the drop box 32 via the one or more openings or slots 142 as discussed above and herein.

For example, items such as currency and/or paperwork can be inserted into one or more chambers 126, 128 of the drop box 32 by passing the items into and through the one or more openings or slots in the gaming table 10, key pad 100 and drop box 32.

For example, items such as receipts, tickets (TITO), coupons, promotions, or account balances can be printed via a ticket printer 130 located in the drop box 32 and presented to a casino dealer or player at the gaming table. In this example, blank tickets or paper can be loaded into a removable drawer 134 within the drop box 32 and fed upwardly to the ticket printer 134. For example, the blank tickets or paper can be laid or stacked horizontally in the drawer 134. The blank tickets or paper can be fed upwardly to the to the ticket printer 134. Upon instruction from the casino dealer, supervisor, or other casino staff, the ticket printer 134 can print information onto the blank tickets or printer, and then present the ticket, coupon, receipt, etc. vertically through one or more of the slots or openings 142 to a casino dealer, staff, or player. In another example, the blank tickets or paper can be arranged vertically in the drawer 134. When the supply of blank tickets or paper is reduced to a certain threshold, the dealer or other casino personal can open or unlock one or more doors 136 to the drop box 32, remove or slide the drawer 134 out of the drop box 32 (e.g., FIG. 4) and refill or add additional blank tickets or paper to the drawer 134. The drawer 134 can then be slid back into the drop box and the door closed for continued operation.

In another example, the drawer 134 may contain a supply or used or redeemed tickets or coupons that have been presented by casino patrons to the dealer for game play. When the drawer 134 reaches a full or certain level, the dealer or staff can be notified to empty the drawer 134 of the redeemed tickets.

In another example, the region of the drop box 32 there the printer 130 is located may be a first chamber and the region where the drawer 134 is located may be a second chamber of the drop box. The two chambers may be isolated from one another. One of the chambers may be used for gathering or collecting cash, currency, gaming tokens, and the other chamber may be used for collecting ticket vouchers or coupons. The items may be kept separate from one another so that the sorting of currency from tickets is made easier for casino staff later on.

Referring to FIG. 6, the utility box 32 comprises a top surface having a first utility box slot 142. The first utility box slot 142 is aligned with and in communication with the first slot 102 of the multifunctional keypad 100 and the second slot 113 of the multifunctional keypad 100. The utility box 32 comprises a diverter wall 119 that is downstream of the first utility box slot 142 to separate the first chamber 126 and the second chamber 128.

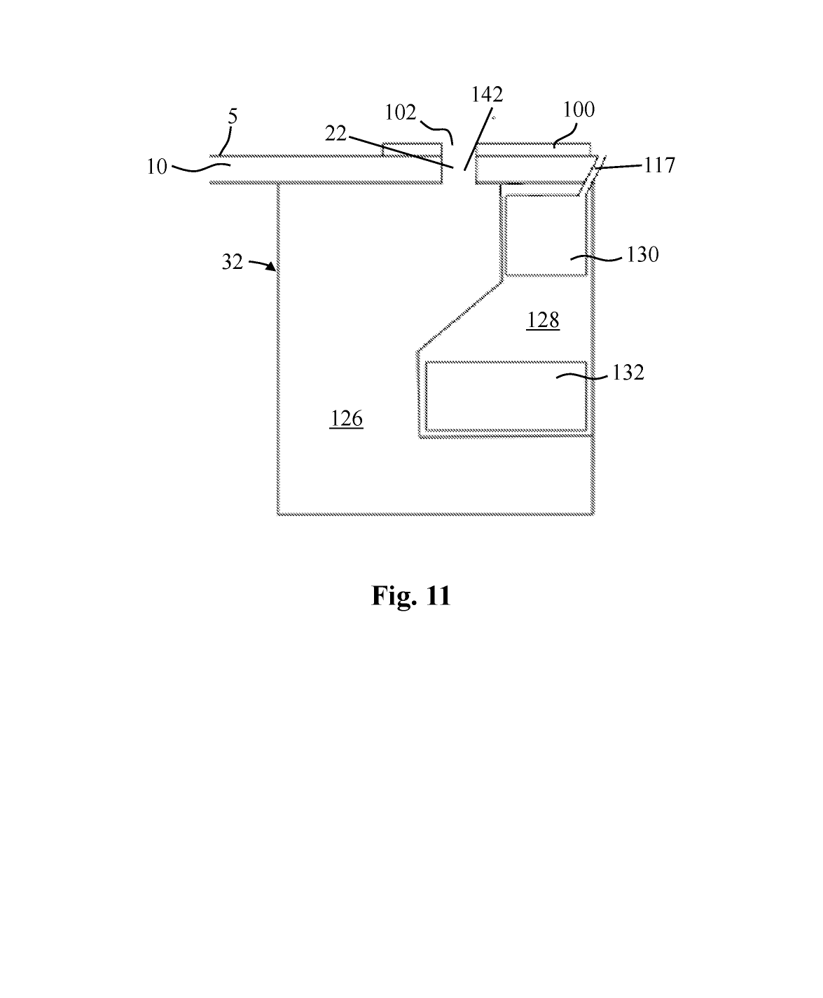

FIG. 11 illustrates a utility box 32 that may be substantially similar to the boxes 32 disclosed above. However, in FIG. 10, the slot 102 in the keypad is in communication with one utility box slot 142 and configured for inserting or depositing cash, currency, vouchers, etc. into the first chamber 126. Tickets or vouchers printed on tickets 132 by a printer 132 located in the second chamber 128 are presented to a dealer of the casino table in a region adjacent to the gaming table 10 (e.g., not through the keypad 100 or through any slot defined in the keypad 100, gaming table 10, etc.). For example, printed tickets may be presented to the dealer through a channel, slot, or chute 117 that has an exit that it located adjacent to the table rather than presenting the ticket onto the top surface of the gaming table.

It is envisioned that the teachings herein can be directed to a method of retrofitting an existing drop box 32. For example, many currency available drop boxes comprise a single chamber that is used for collecting cash, currency, paperwork, tickets, etc. An existing drop box 32 can be retrofitted to include the teachings herein. For example, a printer and computer 130 can be installed in an upper portion of the drop box 32 and a drawer 134 with horizontally arranged tickets can be added to a lower portion of the existing drop box 32. One or more drawer glides or runners can be added to the side walls and/or bottom surface of the inside of the drop box 32 to accommodate a moveable or sliding drawer 134. Blank tickets can be laid horizontally in the drop box or drawer 134 and then be fed vertically to a printer 130 located above the drawer 134 to enable printed tickets to be presented to casino staff or patrons vertically through one or more of the openings or slots 142.

Advantageously, by providing a solution of retrofitting an existing drop box 32, casinos can save cost and time by reusing existing structure and mounting hardware. Moreover, impact on the environment is reduced in that less waste is being added to landfills (e.g., old drop boxes are not being thrown away for replacement by new drop boxes).

Furthermore, by incorporating the ticket printer 130 into the drop box 32, the gaming table has less clutter and distractions to casino patrons and dealers. Furthermore, as casinos enter modern times where cash is being used less frequently for buy-ins, existing drop boxes can be repurposed for newer technology of using printing technology directly at the gaming tables.

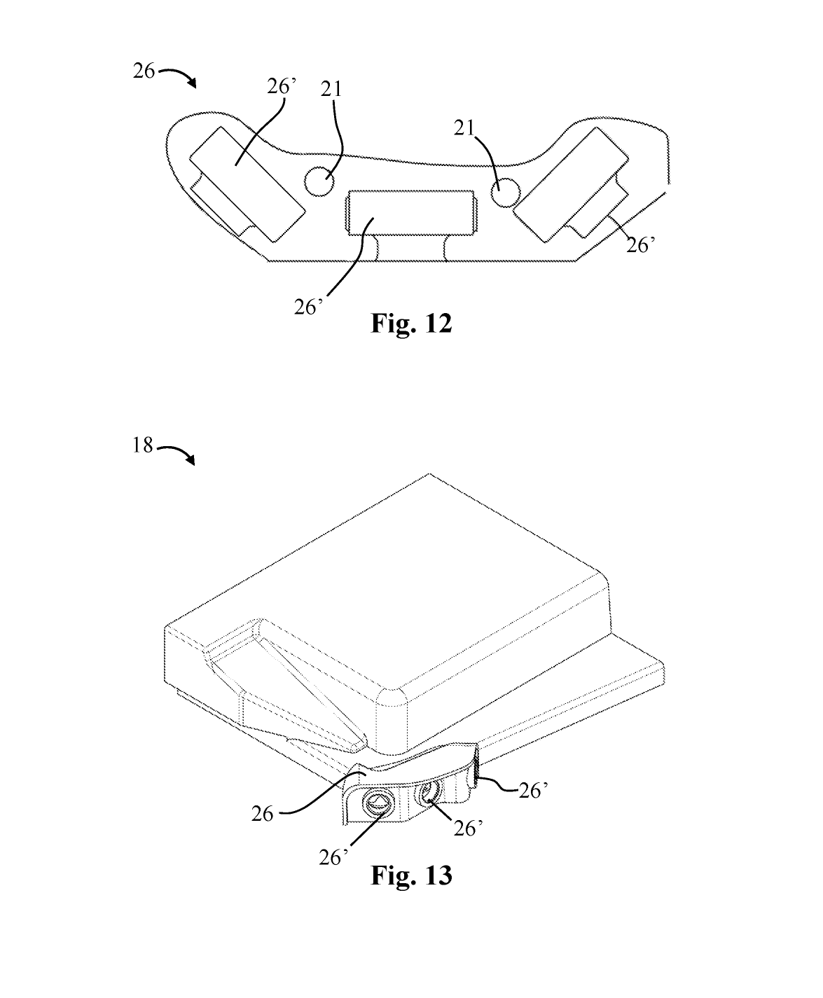

Referring to FIGS. 1, 12, and 13, the casino table may include a chip tray or chip rack 18 that allows a dealer to store betting chips during game play. A chip tray 18 is typically a rectangular box structure that sits on the gaming table 10 or is recessed into the top surface of the gaming table 10. The chip tray 18 may include one or more detection devices 26. The detection devices 26 may be one or more cameras 26’. The one or more detection devices 26 may be arranged at the front region of the chip tray 18, and more specifically at one or both of the front corners of the chip tray 18 that face the player region 12. In the example of FIG. 12, the detection device 26 comprises three cameras 26’; however, it is understood that a detection device 26 may include any number of cameras including only 1 camera, 2 cameras. or even more than 3 cameras.

The detection device 26 is configured to attach to a currently available chip tray 18. The detection device 26 may be located at the front, sides, or corners of the chip tray 18. This may advantageously allow for an existing or legacy chip tray to be outfitted with a detection device in a retrofit manner without requiring a casino to purchase brand new chip trays 18. The detection device 26 may include one or more bores 21 for fasteners to extend through to fasten the detection device 26 to the chip tray 18. In all directions, the detection device 26 may be secured to the chip tray with other fastening methods, such as, for example, using an adhesive, a double sided tape, a hook and loop fastener, or any combination thereof. In other configurations, a detection device may also, or may instead, be mounted directly to the table 10, in a region in front of and or to the side of the chip tray that will still face towards the player region and or the betting regions of interest. The detection device 26 may include one or more more internal ribs for securing or maintaining a position of the one or more cameras 26’ within the detection device structure. The detection device 26 may include a wired or wireless communication from the one or more cameras to the monitoring and detection system 50 and or to the faceplate 100 and or the one or more signs 24.

Referring now to FIG. 14, each of the cameras 26’ of the detection device 26 may have a viewing angle R that is configured to view or monitor a specific region, such as the one or more betting regions 16, of the gaming table. Due to the orientation and number of cameras associated with the detection devices 26 on the chip tray 18, each betting or wagering position 16 may have at least 3 camera views from a side perspective. The overhead system (e.g., cameras in the ceiling of the casino) and/or the camera of the sign 100 may be used for managing the interpretation of the data from the multiple cameras and/or interpreting the camera feed especially if there is a discrepancy in the data. Advantageously, there is camera redundancy with a processing element 50 that might be managed at table level or elsewhere, which determines if all angles match the same value and which camera view holds the biggest weight if there is a discrepancy. This may help ensure that the game play can be accurately viewed and recorded for processing by the system 50 and then information provided to the dealer on the keypad 100 in real time.

A system is disclosed herein that may include one or more signs 24, one or more faceplates 100, and one or more chip trays 18. As disclosed herein, one or more of the signs 24 and chip trays 18 may include one or more cameras, which may work together and referred to as a camera system. The cameras associated with the camera systems may work together to provide input or information to the monitoring and/or processing system 50. One or more cameras of the camera system may be used to monitor casino patrons, casino gaming activity or play, gaming elements (e.g., cards, chips, etc.), casino staff (dealer, supervisor, etc.), or any combination thereof.

If the camera system or the monitoring and/or processing system 50 determines that a gaming table layout has changed, then the system may change numerous settings for the table, visual and any analytics systems. For example, if a game is detected to have changed from a 5 position blackjack game with no secondary (side) wager, to a 6 spot blackjack game with a side wager, the system would adjust numerous items such as adding the side wagers name, a potential pay table, any side wager limits, etc. In addition, the number of seats and any particular rules associated with the layout would transfer to the display. These rules might be displayed constantly, scroll, or only be shown on request. If analytics are performed at the table any related systems would take into account these changes. If the camera system or the monitoring and/or processing system 50 determines that the table has a shuffler, a disclaimer might be displayed on the player facing side of the sign 24. If the camera system or the monitoring and/or processing system 50 determines the table deck size has changed, rules related to the associated deck size, relative to the game type, would change. In addition, the secondary name on the game might change such as changing from Blackjack, to Single Deck Blackjack. Another embodiment would provide notice to the staff that such a change has been detected and provide a recommendation to make the change. If analytics are performed at the table any relative system would take into account these changes.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of "a" or "one" to describe an element or step is not intended to foreclose additional elements or steps. For example, disclosure of “a motor” does not limit the teachings to a single motor. Instead, for example, disclosure of “a motor” may include “one or more motors.”

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The invention illustratively disclosed herein suitably may be practiced in the absence of any element which is not specifically disclosed herein.

Any of the elements, components, regions, layers and/or sections disclosed herein are not necessarily limited to a single embodiment. Instead, any of the elements, components, regions, layers and/or sections disclosed herein may be substituted, combined, and/or modified with any of the elements, components, regions, layers and/or sections disclosed herein to form one or more embodiments that may not be specifically illustrated or described herein.

The disclosures of all articles and references, including patent applications and publications, testing specifications, are incorporated by reference for all purposes. Other combinations are also possible as will be gleaned from the following claims, which are also hereby incorporated by reference into this written description.

1. A multifunctional keypad for a gaming table at a casino, the gaming table comprising an upper gaming surface covered in a felt or fabric material, and located at the upper gaming surface is a chip tray comprising gaming chips, a card shoe comprising playing cards, and one or more betting regions, wherein the multifunctional keypad is configured to be installed on the upper gaming surface and electrically connected to a table monitoring system, the table monitoring system comprising a processor and a memory storing rules for calculating game play activity at the gaming table based on gameplay data received from one or more detection devices that are provided at or adjacent to the gaming table, the processor being configured to receive the gameplay data, timestamp the gameplay data, and then generate a dealer performance metric, wherein the multifunctional keypad comprises one or more attachment devices for securing the multifunctional keypad to the upper gaming surface of the gaming table; an electronics device; one or more communication devices electrically connecting the electronics device to the table monitoring system; a slot through which currency and/or paperwork is configured to be passed through the multifunctional keypad and into a drop box or utility box located under the gaming table; one or more input devices electrically connected to the electronics device and accessible to the dealer to input information into the electronics device of the multifunctional keypad and to display information on a table sign positioned at or adjacent to the gaming table that is electrically connected to the multifunctional keypad for viewing by one or more players at the gaming table; and one or more output devices electrically connected to the electronics device and accessible to the dealer for a dealer alert to be communicated to the dealer at the gaming table in real time during game play; wherein the dealer alert conveys the dealer performance metric, which includes one or more of:
(a) aggregate number of hands dealt per time interval;
(b) a rolling average of hands dealt by the dealer;
(c) whether the rolling average is above or below a threshold;
(d) a number of winning hands and/or losing hands dealt by the dealer; and
(e) a number of hands dealt by the dealer since a last card shuffle.

2. The multifunctional keypad of claim 1, wherein the dealer alert conveys dealer assistance information to the dealer including one or more of:
(a) a number of hands dealt by the dealer since a last card shuffle;
(b) a number of hands carried over from a previous dealing session prior to a dealer break;
(c) an amount of time remaining in the dealer’s shift or until a next scheduled break; and
(d) an indication of an error detected during game play based on the gameplay data processed by the processor.

3. The multifunctional keypad of claim 2, wherein, to generate the dealer assistance information, the processor is further configured to:
(a) process the gameplay data to generate a predicted game outcome;
(b) compare the predicted game outcome to an actual game outcome; and
(c) generate corresponding dealer assistance information,
wherein the dealer alert conveys one or more of:
(i) a payout value calculated by the processor to assist the dealer in determining how much to pay a player for a winning outcome;
(ii) rules of the game relevant to the actual outcome; and
(iii) instructions generated by the processor for guiding the dealer in resolving a discrepancy with a player.

4. The multifunctional keypad of claim 3, wherein the one or more output devices comprise a display screen configured to present the dealer alert, including dealer performance information and dealer assistance information, to the dealer at the gaming table.

5. The multifunctional keypad of claim 4, wherein the one or more output devices comprise one or more devices selected from the group consisting of:
(a) a light indicator,
(b) a speaker configured to generate an audio alert, and
(c) a haptic feedback device configured to vibrate, to notify the dealer of the dealer alert in real time during game play.

6. The multifunctional keypad of claim 5, wherein the one or more input devices comprise one or more devices selected from the group consisting of:
(a) a touchscreen,
(b) a liquid crystal display with integrated touch input,
(c) a button, knob, or switch,
(d) a physical keypad, and
(e) a microphone for receiving audio input.

7. The multifunctional keypad of claim 6, wherein the one or more detection devices comprise one or more cameras positioned at the table sign, the chip tray, and/or connected to a casino surveillance system, the cameras being configured to capture gameplay data relating to cards, chips, or betting activity.

8. The multifunctional keypad of claim 7, wherein the dealer alert conveys player information retrieved by the processor from a player database of the table monitoring system, the player information including whether the player has previously presented a loyalty card or other identifying information to the casino.

9. The multifunctional keypad of claim 8, wherein the dealer alert conveys player status information retrieved by the processor from the player database, the player status information indicating whether the player has been identified by the casino or the table monitoring system as an advantage player.

10. The multifunctional keypad of claim 9, wherein the dealer alert conveys player restriction information retrieved by the processor from the player database, the player restriction information indicating whether the player has been identified by the casino or the table monitoring system as a banned player.

11. The multifunctional keypad of claim 1, wherein the processor of the table monitoring system is configured to communicate the dealer alert to the multifunctional keypad within less than two seconds after the processor receives the gameplay data from the one or more detection devices.

12. A method of operating a multifunctional keypad at a gaming table in a casino, the gaming table comprising an upper gaming surface covered in a felt or fabric material, a chip tray comprising gaming chips, a card shoe comprising playing cards, and one or more betting regions, the method comprising:
installing a multifunctional keypad on the upper gaming surface of the gaming table and electrically connecting the multifunctional keypad to a table monitoring system, the multifunctional keypad comprising: one or more attachment devices for securing the multifunctional keypad to the upper gaming surface; an electronics device; one or more communication devices for electrically connecting the electronics device to the table monitoring system; a slot through which currency and/or paperwork is passed from the multifunctional keypad into a drop box or utility box located under the gaming table; one or more input devices accessible to a dealer to input information into the electronics device and to display information on a table sign positioned at or adjacent to the gaming table for viewing by one or more players at the gaming table; and one or more output devices accessible to the dealer;
receiving, by the table monitoring system, gameplay data from one or more detection devices provided at or adjacent to the gaming table;
timestamping the gameplay data;
generating, by the processor of the table monitoring system, a dealer performance metric based on the gameplay data; and
communicating, through the one or more output devices of the multifunctional keypad, a dealer alert in real time during game play, the dealer alert conveying the dealer performance metric, the dealer performance metric comprising one or more of:
(a) an aggregate number of hands dealt per time interval;
(b) a rolling average of hands dealt by the dealer;
(c) whether the rolling average is above or below a threshold;
(d) a number of winning hands and/or losing hands dealt by the dealer; and
(e) a number of hands dealt by the dealer since a last card shuffle.

13. The method of claim 12, wherein the dealer alert further conveys dealer assistance information including one or more of:
(a) a number of hands dealt since a last card shuffle;
(b) a number of hands carried over from a previous dealing session prior to a dealer break;
(c) an amount of time remaining in the dealer’s shift or until a next scheduled break; or
(d) an indication of an error detected during game play based on the gameplay data processed by the processor.

14. The method of claim 12, further comprising generating, by the processor, dealer assistance information by:
(a) processing the gameplay data to generate a predicted game outcome;
(b) comparing the predicted outcome to an actual game outcome; and
(c) generating instructions for the dealer,
wherein the dealer alert conveys one or more of:
(i) a payout value calculated by the processor;
(ii) rules of the game relevant to the actual outcome; or
(iii) instructions for guiding the dealer in resolving a discrepancy with a player.

15. The method of claim 12, further comprising retrieving, by the processor, player information from a player database of the table monitoring system, the player information including whether the player has previously presented a loyalty card or other identifying information and/or whether the player has been identified as an advantage player and/or whether the player has been identified as a banned player.

16. The method of claim 12, further comprising displaying, by a display screen of the multifunctional keypad, the dealer alert including dealer assistance information, the dealer assistance information comprising:
(i) a payout value calculated by the processor;
(ii) rules of the game relevant to the actual outcome; or
(iii) instructions for guiding the dealer in resolving a discrepancy with a player.

17. The method of claim 12, wherein communicating the dealer alert to the multifunctional keypad occurs within less than two seconds after the processor receives the gameplay data.

18. The method of claim 12, wherein the method comprises receiving, at a card reader of a multifunctional keypad positioned on the gaming table, player identification data associated with a player; retrieving, via a processor of a table monitoring system, player information from a database based on the player identification data; displaying a message or greeting corresponding to the player information on a front screen of a table sign oriented toward one or more players; prompting a dealer to input additional player-related data comprising at least one of: a seat number, buy-in information, and transaction details; generating and storing a timestamp corresponding to the player’s arrival at the table; staging, by the processor, the player identification data and the additional player-related data into a queue for later processing; displaying, on a rear screen of the table sign and/or the multifunctional keypad, an indicator of the pending transaction; notifying a supervisor or pit boss of the pending transaction via at least one of: a visual indicator, a color change, a pulsed light on the rear screen, or a message on a remote monitoring device; and allowing the player to begin or continue gameplay while the staged information is queued for later entry into a player rating system by the supervisor or pit boss.

19. The method of claim 12, wherein the method comprises: receiving, at a tip input device of a multifunctional keypad, a tip input from a dealer indicating receipt of a tip; verifying, by a chip recognition application associated with the keypad or table monitoring system, the tip amount using one or more detection devices; storing the verified tip amount in a digital wallet associated with at least one of the dealer or the casino; generating, via an output device, a visual, audible, or tactile response upon receipt of the tip input, the output device comprising at least one of a light, screen, speaker, or vibration device; displaying, on a table sign or keypad, at least one of: a running tally of tips, a tip percentage rate, a number of hands for which the dealer received tips, or a projected tip rate; and recycling a gaming chip provided as a tip by registering the chip as a tip, recording its value in the digital wallet, and returning the chip to a chip tray for continued circulation during gameplay.

20. The method of claim 12, wherein the method comprises monitoring, by a table monitoring system, gameplay activity and player decision-making times; generating, by a processor of the monitoring system or casino operations, a recommendation when a player exceeds a predetermined decision-making threshold or when a dealer’s table staging time exceeds a desired pace; communicating the recommendation to the dealer via a keypad display or a staff-facing display of a hybrid signage system, the recommendation comprising at least one of: (i) a suggestion to prompt a player to act, (ii) guidance to assist a player in making a decision, or (iii) guidance to improve the dealer’s staging pace relative to average or desired timings; and registering, when a dealer returns from a break, the dealer as the incoming dealer via a staff-facing screen in a process referred to as “Tapping In,” wherein if a player is still active at the table, the staff-facing display provides the recommendation privately to the dealer without being visible to players or patrons.
